(19) United States
(12) Patent Application Publication
(10) Pub. No.: US 2018/0176129 A1
(43) Pub. Date: Jun. 21, 2018

(54) COMMUNICATION METHOD, CONTROL DEVICE, AND SYSTEM

(71) Applicant: FUJITSU LIMITED, Kawasaki-shi (JP)

(72) Inventors: Yasuki Fujii, Kawasaki (JP); Kenichi Fukuda, Yokohama (JP); Toshihiko Kurita, Kawasaki (JP); Takeshi Kawasaki, Kawasaki (JP)

(73) Assignee: FUJITSU LIMITED, Kawasaki-shi (JP)

(21) Appl. No.: 15/822,371

(22) Filed: Nov. 27, 2017

(30) Foreign Application Priority Data
Dec. 15, 2016 (JP) 2016-243591
Aug. 2, 2017 (JP) 2017-150270

(51) Int. Cl. H04L 12/721; H04L 12/42

(52) U.S. Cl. CPC H04L 45/72; H04L 12/42

(57) ABSTRACT

A communication method executed by a processor included in a control device that controls a plurality of transfer devices that store a combination of a content name and a port which is an output destination of an acquisition request for content identified by the content name, the method communication method includes retrieving a loop path that passes through at least part of the plurality of transfer devices; generating a control packet that requests each of the plurality of transfer devices included in the loop path to replace the combination for content acquirable via the loop path with information on which common identification information included in common in the content name that identifies the content acquirable via the loop path is associated with an output port when the loop path is used; and transmitting the generated control packet to each of the plurality of transfer devices included in the loop path.

### CROSS-REFERENCE TO RELATED APPLICATIONS

This application is based upon and claims the benefit of priority of the prior Japanese Patent Application Nos. 2017-150270, filed on Aug. 2, 2017, and 2016-243591, filed on Dec. 15, 2016, the entire contents of which are incorporated herein by reference.

### FIELD

The embodiments discussed herein are related to a communication method, a control device, and a system.

### BACKGROUND

In the Internet in recent years, high volume contents such as video contents has an increasing proportion in the entire traffic. In an internet protocol (IP) network, an IP address assigned to a server that stores contents is retrieved from the name of the server that stores the contents by using a DNS server. A device that attempts to acquire contents accesses the server that stores the contents using the retrieved IP address and acquires the contents. Like this, in an IP network, when contents are acquired, processing for performing communication to retrieve information used for content acquisition is involved.

Thus, attention is being given to information-centric network. In an information-centric network, a message for requesting data transfer and data of contents are transferred using content name as identification information. For this reason, when contents are acquired, the information-centric network is probably more efficient than the IP network.

FIG. 1 is a diagram illustrating an example information-centric network. In FIG. 1, the port number of each node is written subsequent to #. FIG. 1 is example communication in named data networking (NDN) which is a system of the information-centric network. Each node in a network stores a table (forwarding information base) on which content name is associated by an output port used when the contents are acquired. A device that requests contents generates a content request message (interest packet) including a content name, and transmits the content request message from the port of an entry having the longest match with the content name out of the entries in the table.

For instance, it is assumed that a node C of FIG. 1 generates a content request message M1 for requesting contents with a content name of /a/a. In the example of FIG. 1, in a table that stores nodes A to E, the content name of /a/a is associated with port #1. Thus, the node C transmits the content request message M1 from the port #1 (arrow Aa).

When receiving the content request message M1 from port #2, the node B stores the reception port (port #2) of the content request message M1 in association with the content name. Also in the node B, the content name requested in the content request message M1 is associated with port #1. Thus, the node B outputs the content request message M1 from the port #1 (arrow Ab).

When receiving the content request message M1 from port #3, the node A stores the reception port (port #3) of the content request message M1 in association with the content name. Also in the node A, the content name requested in the content request message M1 is associated with the port #1. Thus, the node A outputs the content request message M1 from the port #1 (arrow Ac). Consequently, the content request message M1 arrives at a server 5 that stores contents with the content name of /a/a.

The server 5 generates a packet including the contents with the content name of /a/a, and outputs the generated packet from the port which has received the content request message M1. When receiving the packet including the contents, each of the nodes A, B transmits the packet including the contents from the reception port of the content request message M1. Thus, the node C which has transmitted the content request message M1 may receive the packet including the contents.

As related art, a method of reducing the volume of request messages transmitted by a client device in a distribution network that distributes contents by dividing the contents into one or more objects has been proposed (for instance, Japanese Laid-open Patent Publication No. 2016-115209). In this communication method, a client device transmits a request message including information that indicates multiple object names having a common prefix in the object names.

In a system using the NDN, a combination of a content name and an output port used when the contents are acquired are stored content-by-content. For this reason, there is a problem in that as the number of contents increases, the volume of information stored in each node in a network increases. In consideration of the above situation, it is desirable to reduce the volume of information stored by a node for transfer processing.

### SUMMARY

According to an aspect of the invention, a communication method executed by a processor included in a control device that controls a plurality of transfer devices that store a combination of a content name and a port which is an output destination of an acquisition request for content identified by the content name, the method communication method includes retrieving a loop path that passes through at least part of the plurality of transfer devices; generating a control packet that requests each of the plurality of transfer devices included in the loop path to replace the combination for content acquirable via the loop path with information on which common identification information included in common in the content name that identifies the content acquirable via the loop path is associated with an output port when the loop path is used; and transmitting the generated control packet to each of the plurality of transfer devices included in the loop path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example information-centric network;

FIG. 2 is a diagram illustrating an example communication method according to an embodiment;

FIG. 3 is a diagram illustrating an example configuration of a control device;

FIG. 4 is a diagram illustrating example information to be stored by the control device;

FIG. 5 is a diagram illustrating example content information;

FIG. 6 is a diagram illustrating an example configuration of a transfer device;

FIG. 7 is a diagram illustrating an example hardware configuration of the control device and the transfer device;

FIG. 8 is a diagram illustrating an example network;

FIG. 9 is a diagram illustrating example information transfer table information;

FIG. 10 is a diagram illustrating an example control packet used when an information transfer table is set;

FIG. 11 is a diagram illustrating example update of the information transfer table;

FIG. 12 is a diagram illustrating example transmission of a request message after the information transfer table is updated;

FIG. 13 is a diagram illustrating example transmission of data after the information transfer table is updated;

FIG. 14 is a flowchart illustrating example processing of the control device;

FIG. 15 is a diagram illustrating example retrieval of a loop in a second embodiment, and example update of information transfer table information;

FIG. 16 is a diagram illustrating example update of information transfer table information;

FIG. 17 is a diagram illustrating example update of information transfer table information;

FIG. 18 is a diagram illustrating example retrieval of a loop in the second embodiment, and example update of information transfer table information;

FIG. 19 is a flowchart illustrating example processing of the control device;

FIG. 20 is a diagram illustrating an example configuration of a transfer device according to a third embodiment;

FIG. 21 is a flowchart illustrating example processing of the control device;

FIGS. 22A and 22B are flowcharts illustrating example processing of the transfer device;

FIG. 23 is a diagram illustrating an example information transfer table;

FIG. 24 is a diagram illustrating example retrieval of a loop in a fourth embodiment, and example update of information transfer table information;

FIG. 25 is a diagram illustrating example update of information transfer table information;

FIG. 26 is a diagram illustrating example retrieval of a loop in the fourth embodiment, and example update of information transfer table information;

FIG. 27 is a diagram illustrating addition control for a loop path;

FIG. 28 is a flowchart illustrating example processing of a control device according to the fourth embodiment; and

FIG. 29 is a diagram illustrating another example of the addition control for a loop path.

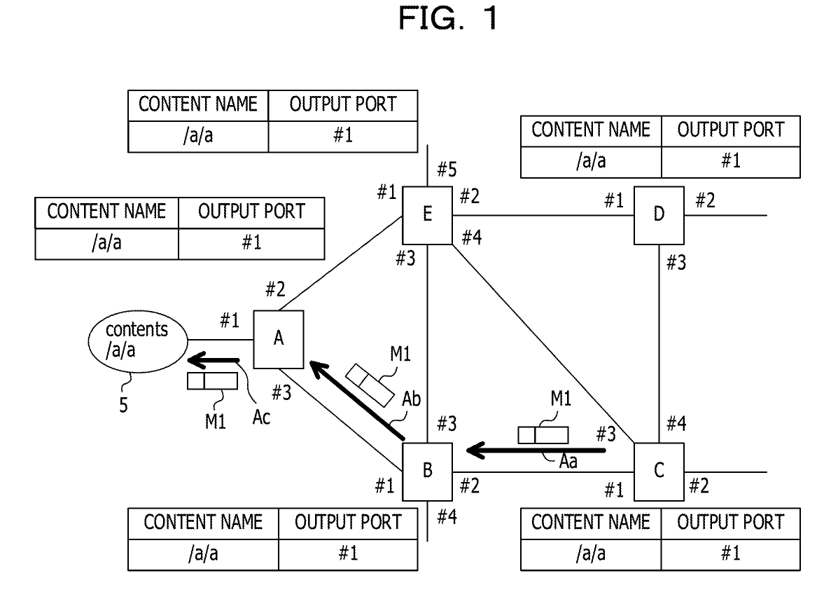

### DESCRIPTION OF EMBODIMENTS

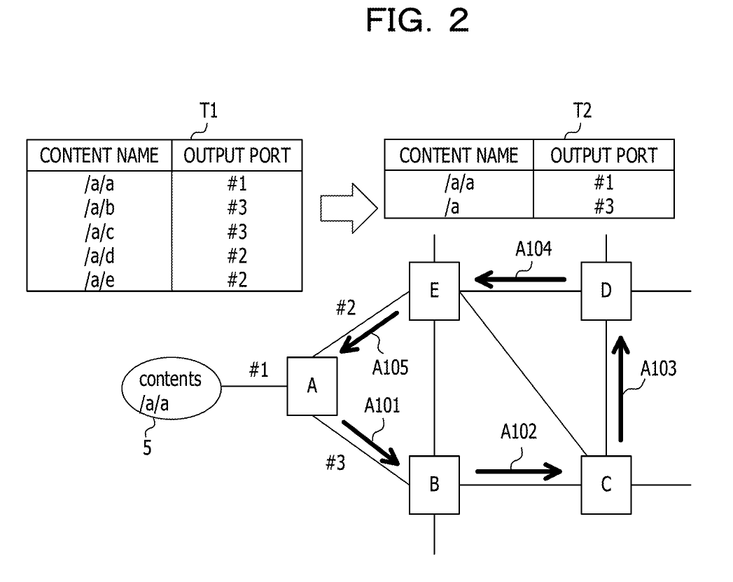

FIG. 2 is a diagram illustrating an example communication method according to an embodiment. In the example of FIG. 2, a control device 10 (not illustrated) controls multiple transfer devices 40 (transfer devices A to E) included in a network. Every time new contents are added to one of the server devices in the network, each of the transfer devices 40 stores a combination of a content name and the port which is an output destination of an acquisition request for the contents identified by the content name. For this reason, when multiple contents are stored in a server device included in the network, each transfer device 40 stores combinations as many as the contents. For instance, when the contents identified by each of /a/a, /a/b, /a/c, /a/d, and /a/e is stored in one of the server devices in the network, a transfer device A stores five combination as illustrated in table T1. Similarly, for each content, the transfer devices B to E also stores a combination of the content name and the output port of an acquisition request for the contents.

The control device 10 retrieves a loop path that passes through the transfer devices 40 in the network. For instance, the control device 10 may retrieve a loop path by solving a Hamiltonian cycle problem using topological information on the network. When finding a loop path, the control device 10 identifies contents acquirable via the loop path for each transfer device 40. For each transfer device 40, the control device 10 identifies contents not stored in the server 5 directly connected to the transfer device 40, as contents acquirable via the loop path. In contrast, for each transfer device 40, the control device 10 determines that the contents stored in the server 5 directly connected to the transfer device 40 is contents acquirable not via the loop path. The control device 10 determines to replace a combination of a content name for contents acquirable via the loop path and an output port with information on which common identification information is associated with an output port when the loop path is used. Here, the common identification information is information in common in a content name that identifies contents acquirable via the loop path.

For instance, it is assumed that in the network illustrated in FIG. 2, as indicated by arrows A101 to A105, a loop path including the transfer device A, the transfer device B, the transfer device C, the transfer device D, the transfer device E is found. Then, the control device 10 determines that for the transfer device A, the contents identified by /a/a is acquirable not via the loop path, however, the contents identified by each of /a/b, /a/c, /a/d, and /a/e is acquirable via the loop path. Furthermore, suppose it is determined that common identification information is “/a” from the content names that identify contents acquirable by the transfer device A using the loop path. For the transfer devices B to E, the control device 10 similarly performs determination processing.

For each transfer device 40, the control device 10 generates a control packet for requesting processing of replacing the information stored by the transfer device 40 with the information using the common identification information. Each transfer device 40 replaces the combination of a content name and an output port with the information including the common identification information in accordance with the control packet from the control device 10. For instance, it is assumed that a control packet is transmitted to the transfer device A, the control packet requesting to replace the combinations each including one of /a/b, /a/c, /a/d, and /a/e with information of common identification information (/a) and an output port with port #3. Then, the transfer device A updates table T1 to table T2 in accordance with the control packet. Subsequently, the transfer device A performs packet transfer processing using the table T2. Specifically, the transfer device A outputs a packet requesting contents with content name of /a/a from the port #1. In contrast, the transfer device A outputs from the port #3 an acquisition request for contents identified by a content name which includes /a and is other than /a/a. Thus, it is possible for the transfer device A to acquire contents other than /a/a, identified by a content name including /a via part of the loop indicated by the arrows A101 to A105.

In other words, in the transfer device A, paths used for acquiring multiple contents other than /a/a are integrated to a path via the loop path. In this manner, acquisition paths for multiple contents are integrated, and accordingly, information for transfer processing, stored by the transfer device A is updated from the state indicated in the table T1 to the state indicated in the table T2. Therefore, the volume of information stored by the transfer device A for transfer processing is reduced.

A specific example of processing of the transfer device A has been described with reference to FIG. 2, and also in other transfer devices 40 included in the loop path in the network, the same processing as in the transfer device A is performed. Therefore, use of the method according to the embodiment allows the volume of information stored by each transfer device 40 in the network for transfer processing to be reduced.

The method described with reference to FIG. 2 is an example. For instance, as described later, when the control device 10 notifies a transfer device of a result of retrieval of a loop path, the transfer device may autonomously integrate information for acquiring multiple contents to information on a path via the loop path. Furthermore, the network illustrated in FIG. 2 is an example, and the number of contents accessible by the transfer devices in a network or a transfer device may be changed in any manner according to implementation.

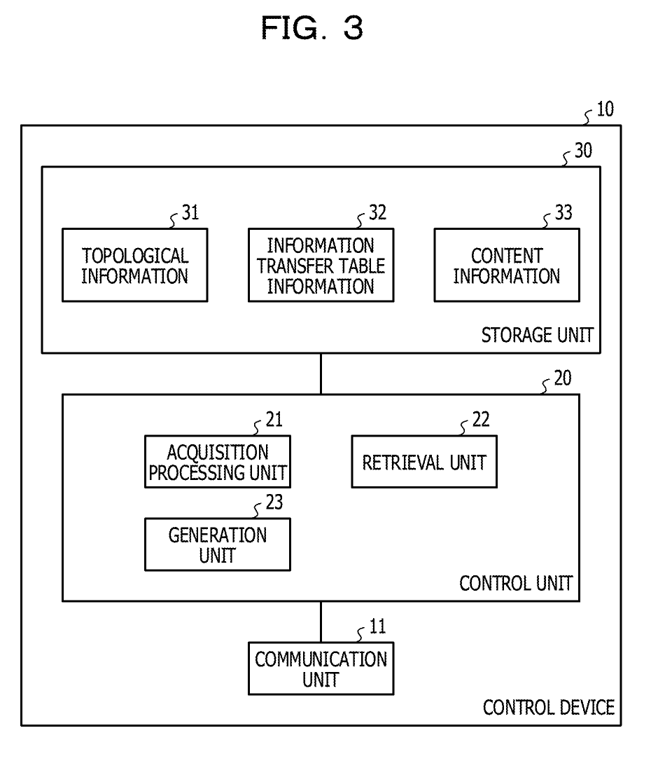

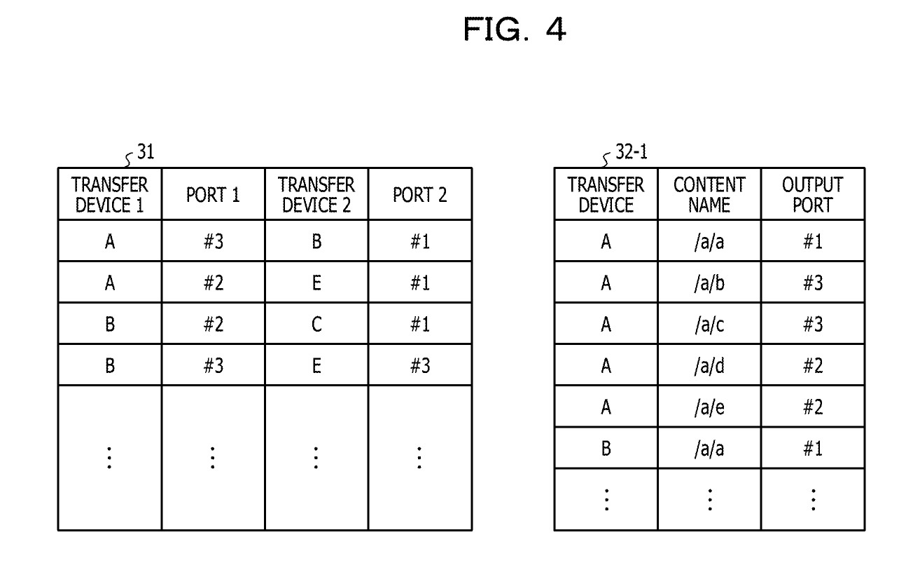

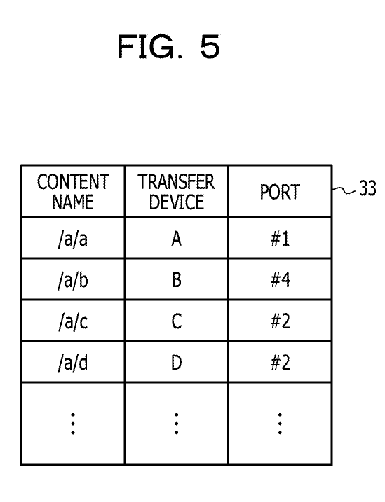

FIG. 3 is a diagram illustrating an example configuration of the control device 10. The control device 10 includes a communication unit 11, a control unit 20, and a storage unit 30. The control unit 20 includes an acquisition processing unit 21, a retrieval unit 22, and a generation unit 23. The storage unit 30 stores topological information 31, information transfer table information 32, and content information 33. Examples of the topological information 31, the information transfer table information 32, and the content information 33 will be described with reference to FIGS. 4 and 5.

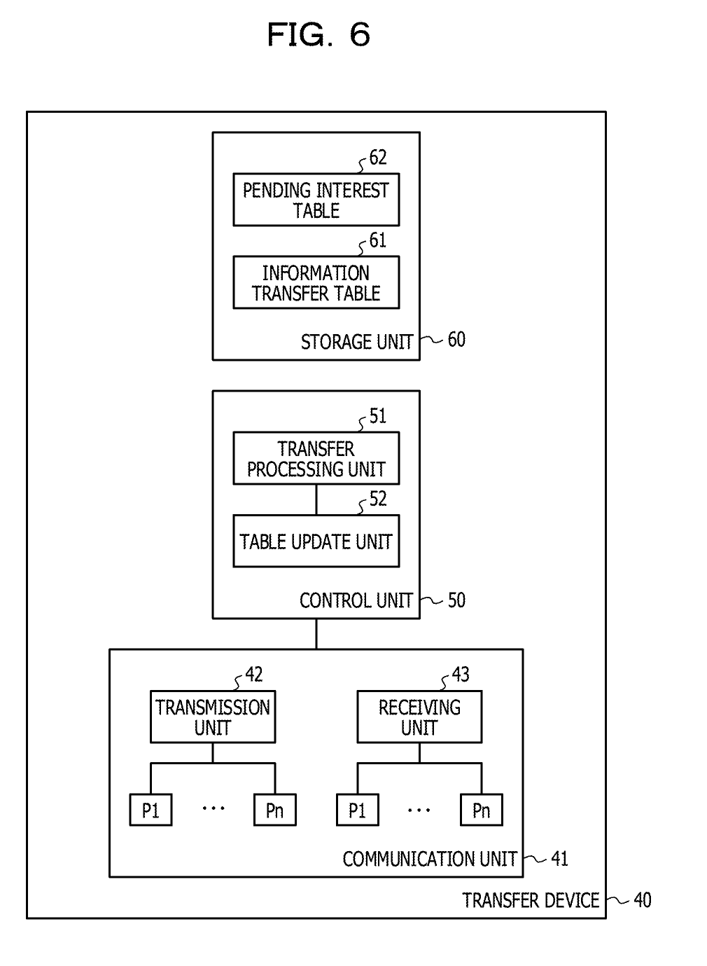

The communication unit 11 transmits and receives a packet such as a control message to and from a transfer device 40 in a network. The acquisition processing unit 21 performs processing for acquiring an information transfer table 61 (FIG. 6) stored by the transfer device 40 in the network. When a trigger to update the information transfer table 61 occurs, the acquisition processing unit 21 requests the retrieval unit 22 to retrieve a loop path. A trigger to update the information transfer table 61 may be, for instance, exceedance of a threshold value by the number of entries included in the information transfer table 61 stored by the transfer device 40. Alternatively, a trigger may be an occurrence of input to the control device 10 from an operator. The retrieval unit 22 retrieves a loop path that passes through multiple transfer devices 40 using the topological information 31. The retrieval unit 22 may determine a loop path which passes through the transfer devices 40 only once in a network, for instance, by solving a Hamiltonian cycle problem where the transfer devices 40 are vertices. For each transfer device 40, the generation unit 23 generates a control packet for requesting updating of the information transfer table 61 stored by the transfer device 40, using a result of retrieval obtained by the retrieval unit 22, the information transfer table information 32, and the content information 33.

FIG. 4 is a diagram illustrating example information to be stored by the control device 10. The topological information 31 associates each port of the transfer devices 40 included in a network with a port of the device connected to the port. For instance, port #3 of the transfer device A is connected to port #1 of the transfer device B. Port #2 of the transfer device A is connected to port #1 of the transfer device E, and port #2 of the transfer device B is connected to port #1 of the transfer device C. In addition, port #3 of the transfer device B is connected to port #3 of the transfer device E.

The information transfer table information 32 is information that summarizes the information stored by each transfer device 40 for transfer processing. In each entry, a combination of a content name and an output port that outputs an acquisition request for the contents is associated with identification information of the transfer device 40 which stores the combination. The control device 10 updates the information transfer table information 32 by communicating with the transfer device 40 regularly.

The information transfer table information 32-1 illustrated in FIG. 4 is an example of the information transfer table information 32 to be stored by the control device 10 before integration processing of paths for multiple contents is performed. According to the information transfer table information 32-1, the transfer device A outputs an acquisition request for the contents identified by the content name of /a/a from the port #1. Furthermore, it is recorded in the information transfer table information 32-1 that the transfer device A outputs an acquisition request for the contents identified by the content name of /a/b or the content name of /a/c from the port #3. It is also recorded in the information transfer table information 32-1 that the transfer device A outputs an acquisition request for the contents identified by the content name of /a/d or the content name of /a/e from the port #2. Similarly, the information used in another transfer device 40 such as the transfer device B is also recorded in the information transfer table information 32. It is recorded in the sixth entry of the information transfer table information 32-1 that the transfer device B outputs an acquisition request for the contents identified by the content name of /a/a from the port #1.

FIG. 5 is a diagram illustrating example content information 33. In the content information 33, for each of the contents accessible by the transfer devices 40 in a network, a content name is associated with information that identifies a port of the transfer device 40 connected to the server in which the contents are stored. In the content information 33 illustrated in FIG. 5, a content name, a transfer device, and a port are associated with each other. The column of transfer device stores the identification information of the transfer device 40 connected to the server in which contents in the entry are stored. The column of port stores the number of a port connected to the server in which contents in the entry are stored, the port being out of the ports provided in the transfer devices 40 each of which is identified for identification information in the entry.

For instance, it is recorded in the first entry of the content information 33 in FIG. 5 that the contents identified by the content name of /a/a is stored in the server connected to the port #1 of the transfer device A. Similarly, it is recorded in the second entry that the contents identified by the content name of /a/b is stored in the server connected to the port #4 of the transfer device B. From the third entry, it is identified that the contents identified by the content name of /a/c is stored in the server connected to the port #2 of the transfer device C. From the fourth entry, it is identified that the contents identified by the content name of /a/d is stored in the server connected to the port #2 of the transfer device D.

FIG. 6 is a diagram illustrating an example configuration of the transfer device 40. The transfer device 40 includes a communication unit 41, a control unit 50, and a storage unit 60. The communication unit 41 includes a transmission unit 42 and a receiving unit 43, and also further includes ports (P1 to Pn) used for the transmission unit 42 and the receiving unit 43. Each port is connected to each of the communication unit 41 and the transmission unit 42. In the example of FIG. 6, in order to make FIG. 6 easier to understand, the output port and the input port are separately illustrated, and the port number of each port is identified by a numerical value following P. For instance, P1 indicates port #1 in the transfer device 40, and Pn indicates port n (n is an integer). The control unit 50 includes a transfer processing unit 51 and a table update unit 52. The storage unit 60 stores an information transfer table 61 and a pending interest table 62.

The information transfer table 61 associates a content name with the number of the port which is an output destination that outputs an acquisition request for the contents identified by the content name. The control device 10 is regularly notified of the information of the information transfer table 61, which is stored as the information transfer table information 32 in the control device 10. The pending interest table 62 is information that for an acquisition request which is not replied with contents after the acquisition request is outputted by the transfer device 40, associates a receiving port of the acquisition request with a content name included in the acquisition request. Examples of the information transfer table 61 or the pending interest table 62 will be described later.

The transmission unit 42 transmits a packet to another transfer device 40, another device such as the control device 10, or a server. The receiving unit 43 receives a packet from another transfer device 40, another device such as the control device 10, or a server.

The transfer processing unit 51 performs processing for packet transfer such as identifying the port used for packet transfer by using the information transfer table 61 and the pending interest table 62. The table update unit 52 performs update processing for the information transfer table 61 and the pending interest table 62.

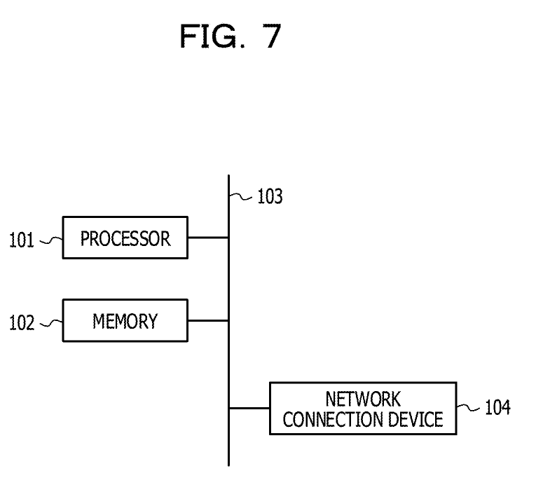

FIG. 7 is a diagram illustrating an example hardware configuration of the control device 10 and the transfer device 40. Each of the control device 10 and the transfer device 40 includes a processor 101, a memory 102, a bus 103, and a network connection device 104. The processor 101 is any processing circuit, for instance, may be a central processing unit (CPU). The processor 101 performs various types of processing by executing a program using the memory 102 as a working memory. The memory 102 includes a random access memory (RAM), and also further includes a non-volatile memory such as a read only memory (ROM). The memory 102 is used for storing data to be used for processing in a program or the processor 101. The network connection device 104 is used for communication with another device via a network. The bus 103 connects the processor 101, the memory 102, and the network connection device 104 to allow input and output of data mutually.

In the control device 10, the processor 101 operates as the control unit 20, and the memory 102 operates as the storage unit 30. In addition, the network connection device 104 operates as the communication unit 11. Although not illustrated in FIG. 7, the control device 10 may further store an input device for inputting instructions by an operator, or a display device for displaying information stored by the control device 10 to be visually recognizable by an operator. The input device is, for instance, a keyboard. The display device is, for instance, a display.

In the transfer device 40, the processor 101 operates as the control unit 50, and the memory 102 operates as the storage unit 60. In addition, the network connection device 104 operates as the communication unit 41.

### First Embodiment

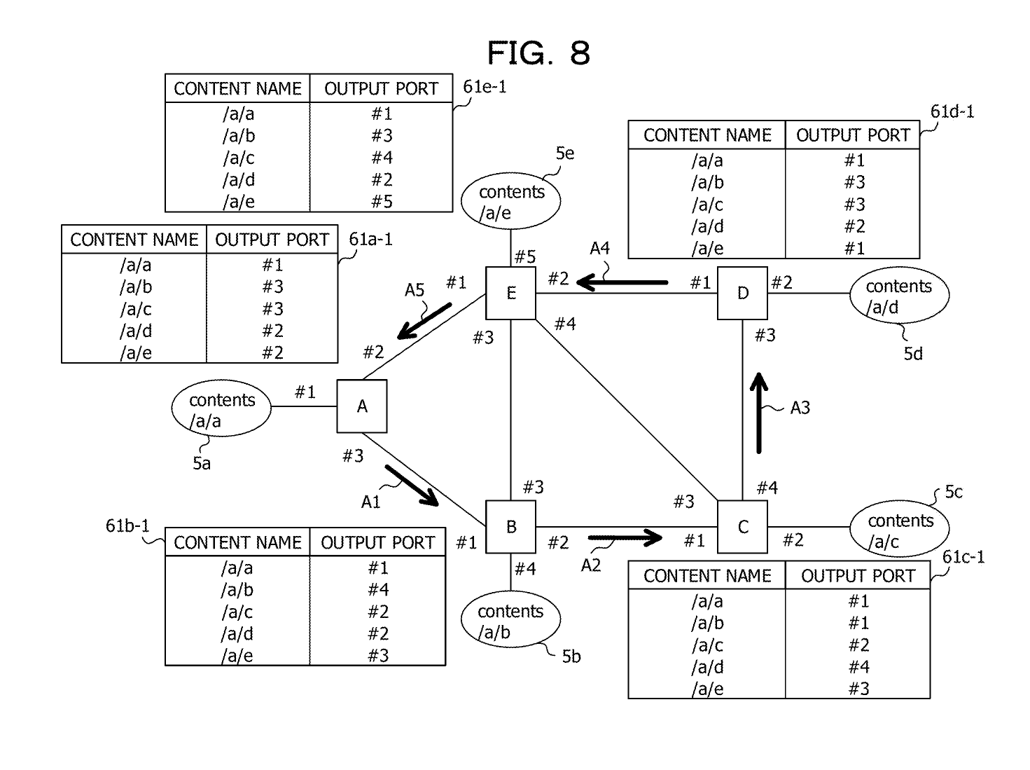

FIG. 8 is a diagram illustrating an example network. In the example of FIG. 8, a network includes multiple transfer devices 40 (transfer devices A to E), multiple servers 5 (5a to 5e), and the control device 10 (not illustrated). The control device 10 establishes connection between itself and each of the transfer devices 40 in a network using a port for control. The control device 10 and the connection between the control device 10 and the transfer devices are not illustrated in FIG. 8 in order to make FIG. 8 easier to understand. Hereinafter, as an example of the network illustrated in FIG. 8, an example of processing performed in the first embodiment will be described. In the following description, in order to make it clear which transfer device 40 is described, the lower-case letter of the alphabet at the end of the symbol of the transfer device 40 may be written following a symbol. For instance, an information transfer table 61a is the information transfer table 61 to be stored by the transfer device A. A transfer processing unit 51a is the transfer processing unit 51 in the transfer device A.

In the network illustrated in FIG. 8, the server 5a stores contents /a/a, and the server 5b stores contents /a/b. A server 5c stores contents /a/c, and a server 5d stores contents /a/d. Furthermore, a server 5e stores contents /a/e. When the network is as illustrated in FIG. 8, an example of the content information 33 to be stored by the control device 10 is as illustrated in FIG. 5. Similarly, when the network is as illustrated in FIG. 8, an example of the topological information 31 to be stored by the control device 10 is as illustrated in FIG. 4. Although not all connections are illustrated in the topological information 31 of FIG. 4, the topological information 31 records all connection relationships in the network illustrated in FIG. 8.

FIG. 8 also illustrates an example of the information transfer table 61 to be stored by each transfer device 40. In the stage illustrated in FIG. 8, for all contents, each transfer device 40 separately stores the combination of a content name and an output port in the information transfer table 61. For instance, at the time of FIG. 8, the transfer processing unit 51a of the transfer device A stores an information transfer table 61a-1. Consequently, at the time of FIG. 8, the transfer device A outputs an acquisition request for contents /a/a from the port #1. Similarly, the transfer device A outputs an acquisition request for contents /a/b and contents /a/c from the port #3, and outputs an acquisition request for contents /a/d and contents /a/e from the port #2. Similarly, another transfer device 40 also determines an output destination of the acquisition request in accordance with the information transfer table 61 stored by the transfer device 40. For instance, the transfer device B determines an output destination of the acquisition request in accordance with an information transfer table 61b-1. The transfer device C then determines an output destination of the acquisition request in accordance with an information transfer table 61c-1. Similarly, the transfer device D determines an output destination of the acquisition request in accordance with an information transfer table 61d-1. The transfer device E then determines an output destination of the acquisition request in accordance with an information transfer table 61e-1.

For each of the transfer devices A to E, the acquisition processing unit 21 of the control device 10 generates a control packet that requests notification of information of the information transfer table 61. The acquisition processing unit 21 then transmits the control packet to each transfer device 40 via the communication unit 11.

When receiving the control packet, the receiving unit 43a of the transfer device A outputs the control packet to the transfer processing unit 51a. Since the control packet is addressed to the transfer device A itself, the transfer processing unit 51a outputs the control packet to the table update unit 52a without transferring the control packet. When obtaining the control packet that requests transfer of the information transfer table 61, the table update unit 52a generates a packet including the information of the information transfer table 61a-1. The packet including the information of the information transfer table 61a-1 is transmitted to the control device 10 via a transmission unit 42a.

When receiving the packet including the information of the information transfer table 61a-1, the communication unit 11 of the control device 10 outputs the received packet to the acquisition processing unit 21. The acquisition processing unit 21 records the obtained information in the information transfer table information 32.

Similarly to the processing between the control device 10 and the transfer device A, the control device 10 obtains information of the information transfer table 61 between the control device 10 and the transfer devices B to E. Consequently, at the time of FIG. 8, the control device 10 stores the information transfer table information 32-1 (FIG. 4) including all the information of the information transfer tables 61a-1 to 61e-1. In FIG. 4, not all the information in the information transfer table information 32-1 is listed. However, the information transfer table information 32-1 records all the information of the information transfer table 61 stored by each transfer device 40.

The acquisition processing unit 21 regularly compares the number of combinations of a content name and an output port stored in the information transfer table 61 by each transfer device 40 with a threshold value Th. The threshold value Th is for comparing with the number of combinations recorded in the information transfer table 61 in order to determine whether or not the information transfer table 61 is updated. For instance, the threshold value Th=3, and when the number of entries stored by one transfer device 40 exceeds the threshold value Th, the acquisition processing unit 21 is set so as to update the information transfer table 61. In the example of FIG. 8, the number of combinations included in each information transfer table 61 is 5, and exceeds the threshold value Th, thus the acquisition processing unit 21 determines to update the information transfer table 61.

The acquisition processing unit 21 requests the retrieval unit 22 to retrieve a loop path including the transfer devices A to E. The retrieval unit 22 retrieves a loop path including the transfer devices A to E using the topological information 31 (FIG. 4). Any known method is used for processing for retrieval of a loop path. In the example of FIG. 8, it is assumed that as indicated by arrows A1 to A5, the acquisition processing unit 21 has found a loop path starting from the transfer device A and returning to the transfer device A via the transfer device B, the transfer device C, the transfer device D, and the transfer device E sequentially.

Next, the retrieval unit 22 obtains common identification information which is in common in the content names that identify contents for which processing for integrating paths is to be performed. The common identification information may be determined by referring to the information transfer table information 32-1 (FIG. 4) by the retrieval unit 22. Alternatively, an operator may refer to the information transfer table information 32-1, and may determine and input the common identification information to the control device 10. In the following description, it is assumed that paths to contents /a/a, contents /a/b, contents /a/c, contents /a/d, and contents /a/e are selected as an object for which paths are to be integrated. In this case, since /a at the front is in common between the content names of the contents to be integrated, it is determined that /a is the common identification information.

The retrieval unit 22 identifies the contents stored in the server 5 connected to the transfer device A using the topological information 31 (FIG. 4) and the content information 33 (FIG. 5). In this example, the retrieval unit 22 identifies that the contents /a/a is stored in the server 5a connected to the transfer device A. The retrieval unit 22 determines that the contents other than the contents /a/a stored in the server 5a connected to the transfer device A are acquirable by the transfer device A via part of the loop path indicated by the arrows A1 to A5. Thus, in the information on the output port used by the transfer device A, for contents other than the contents /a/a, the retrieval unit 22 sets an output destination of the acquisition request to be a port which is out of the ports of the transfer device A, and from which a packet may be outputted to the loop path. In the example of FIG. 8, a port which is out of the ports of the transfer device A and outputs a packet to the loop path is the port #3. Thus, in the information transfer table information 32-1, the retrieval unit 22 replaces an output destination of the acquisition request for the contents other than the contents /a/a in the transfer device A with the port #3. Furthermore, the retrieval unit 22 replaces each content name other than the contents /a/a in the transfer device A with the common identification information. Thus, when the transfer paths used by the transfer device A are integrated, path information set to the transfer device A is as follows:

contents /a/a, output port: port #1

contents /a, output port: Port #3

The retrieval unit 22 performs similar processing on other transfer devices 40 included in the loop path.

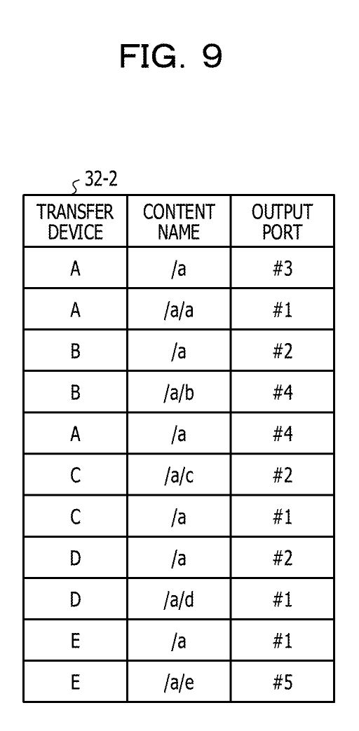

FIG. 9 is a diagram illustrating an example of the information transfer table information 32-2. The information transfer table information 32-2 is an example of obtained information transfer table information 32 as a result of integration of path information for all the transfer devices A to E by the retrieval unit 22. In FIG. 9, the information on the path related to the transfer device A is updated as illustrated in the first and second entries from the top.

As recorded in the content information 33 (FIG. 5), the transfer device B is connected to the server 5b that stores the contents /a/b. Thus, the retrieval unit 22 replaces an output destination of the acquisition request for contents other than the contents /a/b in the transfer device B with the port #2 which is the output port to the loop path. In addition, the content names of contents other than the contents /a/b in the transfer device B are replaced with the common identification information. Thus, in the information transfer table information 32-2, the information on the transfer device B is updated as follows:

contents /a/b, output port: port #4

contents /a, output port: port #2

Similarly, the transfer device C is connected to the server 5c that stores the contents /a/c. Thus, the retrieval unit 22 replaces an output destination of the acquisition request for contents other than the contents /a/c in the transfer device C with the port #4 which is the output port to the loop path. Then, the retrieval unit 22 replaces the content names of contents other than the contents /a/c with the common identification information. Thus, in the information transfer table information 32-2, the information on the transfer device C is updated as follows:

contents /a/c, output port: port #2

contents /a, output port: port #4

The transfer device D is connected to the server 5d that stores the contents /a/d. Thus, the retrieval unit 22 replaces an output destination of the acquisition request for contents other than the contents /a/d in the transfer device D with the port #1 which is the output port to the loop path. Then, the retrieval unit 22 replaces the content names of contents other than the contents /a/d with the common identification information. Thus, in the information transfer table information 32-2, the information on the transfer device D is updated as follows:

contents /a/d, output port: port #2

contents /a, output port: port #1

The transfer device E is connected to the server 5e that stores the contents /a/e. Thus, the retrieval unit 22 replaces an output destination of the acquisition request for contents other than the contents /a/e in the transfer device E with the port #1 which is the output port to the loop path. Then, the retrieval unit 22 replaces the content names of contents other than the contents /a/e with the common identification information. Thus, in the information transfer table information 32-2, the information on the transfer device E is updated as follows:

contents /a/e, output port: port #5

contents /a, output port: port #1

When update of the information transfer table information 32 is completed, the generation unit 23 generates a control packet for requesting each transfer device 40 to update the information transfer table 61.

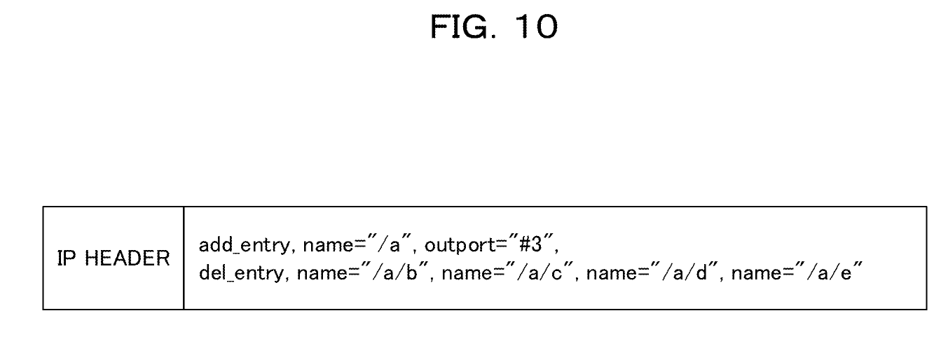

FIG. 10 is a diagram illustrating an example control packet used when the information transfer table is set. In the example of FIG. 10, the generation unit 23 uses add_entry as a command that specifies an entry to be added to the information transfer table 61 stored by the transfer device 40 at the destination of a control packet. Subsequent to add_entry command, specification of content names and output ports included in the entry to be added is written. In the example of FIG. 10, in order to designate the port #3 as the output port of an acquisition request for contents having the longest match with the content name of /a, the following description is used.

add_entry, name=“/a”, outport=“#3”

In addition, del_entry is used as a command that specifies an entry to be deleted from the information transfer table 61 stored by the transfer device 40 at the destination of a control packet. In the example of FIG. 10, in order to delete an entry for each of content name of /a/b, content name of /a/c, content name of /a/d, and content name of /a/e from the information transfer table 61a-1, the following commands are written:

del_entry, name=“/a/b”, name=“/a/c”, name=“/a/d”, name=“/a/e”

The generation unit 23 generates a control packet including those generated commands in data. In this process, the generation unit 23 uses an IP header that designates the destination as the IP address of the transfer device 40 at the destination of the commands. The generation unit 23 transmits the generated control packet to each transfer device 40 via the communication unit 11.

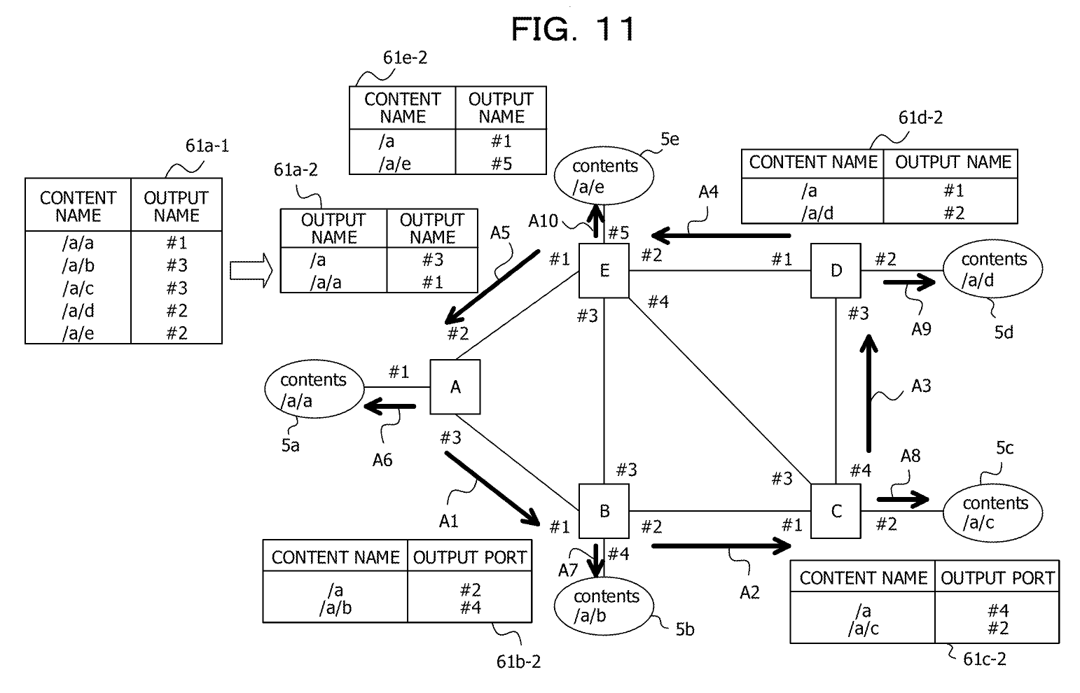

FIG. 11 is a diagram illustrating example update of the information transfer table. First, a case will be described where the transfer device A receives the control packet illustrated in FIG. 10. The receiving unit 43a of the transfer device A receives a control packet transmitted from the control device 10. The table update unit 52a updates the information transfer table 61a-1 in accordance with the control packet. Specifically, an entry indicating that the output port with the content name of /a is the port #3 is added to the information transfer table 61a-1, and the entries with respective content names of /a/b, /a/c, /a/d, and /a/e are deleted. Consequently, the information transfer table 61a-1 is updated as illustrated in the information transfer table 61a-2.

For the transfer devices 40 other than the transfer device A, the generation unit 23 of the control device 10 generates a control packet for achieving consistency between the information transfer table information 32-2 after the update, and the information of the information transfer table 61 stored by each transfer device 40. The control packet is transmitted to the transfer device 40 at each destination, and each transfer device 40 updates the information transfer table 61 in accordance with the control packet. Consequently, the transfer device B updates the information transfer table 61b-1 (FIG. 8) as illustrated in the information transfer table 61b-2. Similarly, the transfer device C updates the information transfer table 61c-1 (FIG. 8) as illustrated in the information transfer table 61c-2. The transfer device D updates the information transfer table 61d-1 (FIG. 8) as illustrated in the information transfer table 61d-2. Furthermore, the transfer device E updates the information transfer table 61e-1 (FIG. 8) as illustrated in the information transfer table 61e-2.

It is assumed that after the update of the information transfer table 61, the transfer devices B to E access the contents identified by the content name of /a/a. In this case, an acquisition request for the contents is transferred to the server 5a via part of the loop path indicated by the arrows A1 to A5 and the path (arrow A6) from the transfer device A to the server 5a. When the transfer device A and the transfer devices C to E access the contents with the content name of /a/b, an acquisition request for the contents is transferred to the server 5b via part of the loop path indicated by the arrows A1 to A5 and the path (arrow A7) from the transfer device B to the server 5b. When the transfer device A, B, D, and E access the contents with the content name of /a/c, an acquisition request for the contents is transferred to the server 5c via part of the loop path indicated by the arrows A1 to A5 and the path (arrow A8) from the transfer device C to the server 5c. When the transfer devices A to C and the transfer device E access the content with the content name of /a/d, an acquisition request for the contents is transferred to the server 5d via part of the loop path indicated by the arrows A1 to A5 and the path (arrow A9) from the transfer device D to the server 5d. In addition, when the transfer devices A to D access the contents with the content name of /a/e, an acquisition request for the contents is transferred to the server 5e via part of the loop path indicated by the arrows A1 to A5 and the path (arrow A10) from the transfer device E to the server 5e.

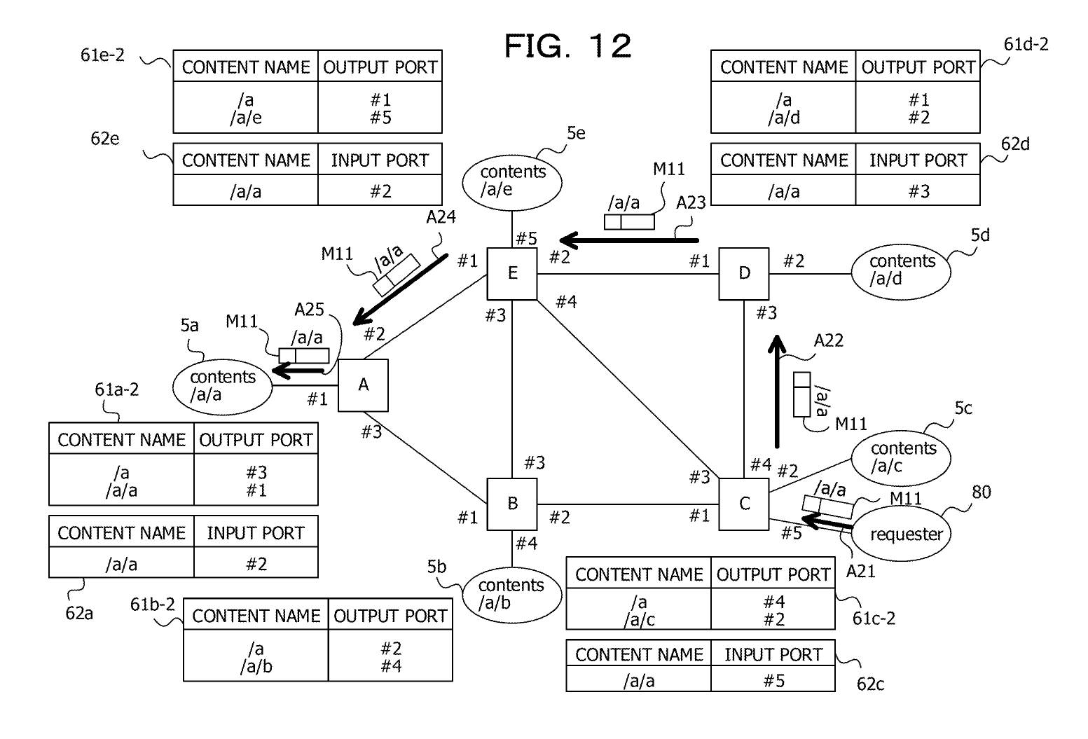

FIG. 12 is a diagram illustrating example transmission of a request message after the information transfer table is updated. Hereinafter, an example of processing performed by each transfer device 40 using the information transfer table 61 after the update will be described when a communication device 80 (requester) connected to the transfer device C attempts to acquire the contents with the content name of /a/a.

First, the communication device 80 generates an acquisition request message M11 for the contents with the content name of /a/a, and transmits the acquisition request message M11 (arrow A21). It is assumed that the acquisition request message M11 has arrived at the transfer device C. The receiving unit 43c of the transfer device C receives the acquisition request message M11 via the port #5.

The table update unit 52c records a receiving port of the acquisition request message M11, and the content name included in the acquisition request message M11 in association with each other in a pending interest table 62c. Thus, the content name of /a/a and the input port with port #5 are recorded in association with each other in the pending interest table 62c. Meanwhile, the transfer processing unit 51c determines a transfer destination by searching the information transfer table 61c-2 using the content name in the acquisition request message M11 as the key. The content name having the longest match with the content name of /a/a in the acquisition request message M11 out of the content names included in the information transfer table 61c-2 is /a. Thus, the transfer processing unit 51c determines that the output port of the acquisition request message M11 is the port #4, and outputs information on the determined port and the acquisition request message M11 to a transmission unit 42c. Since the transmission unit 42c transmits the acquisition request message M11 from the port #4, the acquisition request message M11 is transferred to the transfer device D (arrow A22).

The receiving unit 43d of the transfer device D receives the acquisition request message M11 via the port #3. The table update unit 52drecords the receiving port of the acquisition request message M11, and the content name included in the acquisition request message M11 in association with each other in a pending interest table 62d. Thus, the content name of /a/a and the input port with port #3 are recorded in association with each other in the pending interest table 62d. Meanwhile, the transfer processing unit 51d determines a transfer destination by searching the information transfer table 61d-2 using the content name in the acquisition request message M11 as the key. The content name having the longest match with the content name of /a/a in the acquisition request message M11 out of the content names included in the information transfer table 61d-2 is /a. Thus, the transfer processing unit 51d determines that the output port of the acquisition request message M11 is the port #1. Since the transmission unit 42d transmits the acquisition request message M11 from the port #1, the acquisition request message M11 is transferred to the transfer device E (arrow A23).

The receiving unit 43e of the transfer device E receives the acquisition request message M11 via the port #2. The table update unit 52e records the receiving port of the acquisition request message M11, and the content name included in the acquisition request message M11 in association with each other in a pending interest table 62e. Thus, the content name of /a/a and the input port with port #2 are recorded in association with each other in the pending interest table 62e. Meanwhile, the transfer processing unit 51e determines a transfer destination by searching the information transfer table 61e-2 using the content name in the acquisition request message M11 as the key. The content name having the longest match with the content name of /a/a in the acquisition request message M11 out of the content names included in the information transfer table 61e-2 is /a. Thus, the transfer processing unit 51e determines that the output port of the acquisition request message M11 is the port #1. Since the transmission unit 42e transmits the acquisition request message M11 from the port #1, the acquisition request message M11 is transferred to the transfer device A (arrow A24).

The receiving unit 43a of the transfer device A receives the acquisition request message M11 via the port #2. The table update unit 52a records the receiving port of the acquisition request message M11, and the content name included in the acquisition request message M11 in association with each other in a pending interest table 62a. Thus, the content name of /a/a and the input port with port #2 are recorded in association with each other in the pending interest table 62a. Meanwhile, the transfer processing unit 51a determines a transfer destination by searching the information transfer table 61a-2 using the content name in the acquisition request message M11 as the key. The content name having the longest match with the content name of /a/a in the acquisition request message M11 out of the content names included in the information transfer table 61a-2 is /a/a. Thus, the transfer processing unit 51a determines that the output port of the acquisition request message M11 is the port #1. Since the transmission unit 42a transmits the acquisition request message M11 from the port #1, the acquisition request message M11 is transferred to the server 5a which stores content a/a (arrow A25).

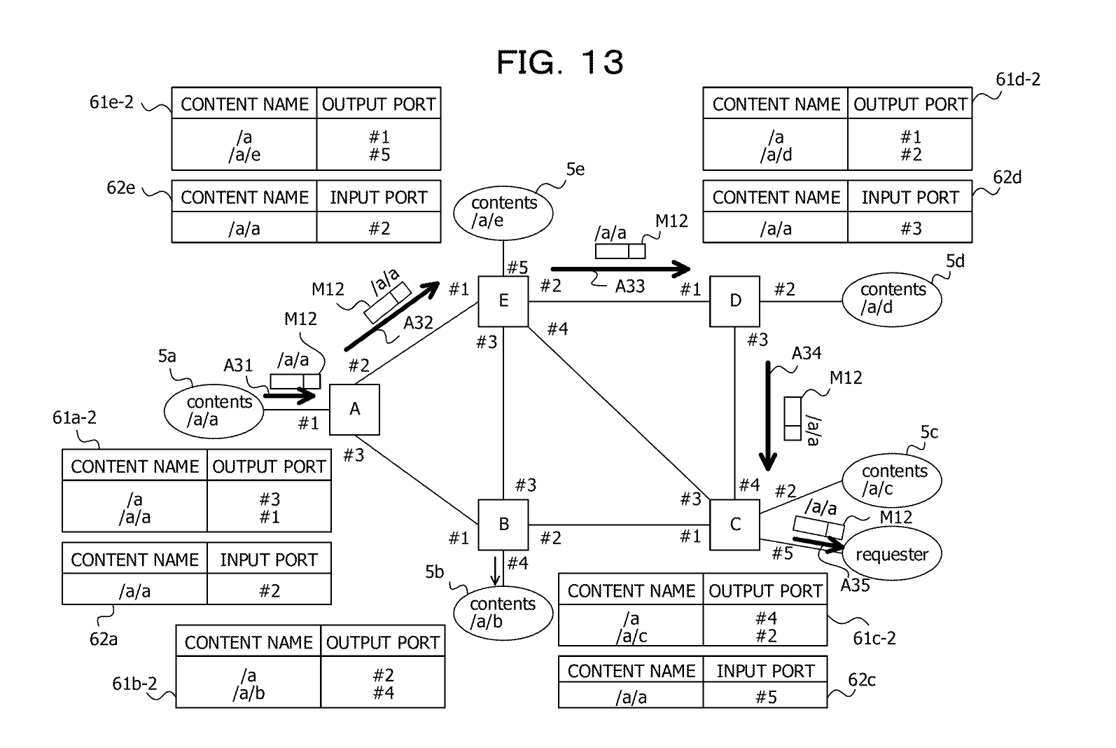

FIG. 13 is a diagram illustrating example transmission of data after the information transfer table is updated. An example of processing performed after the acquisition request message M11 arrives at the server 5a will be described with reference to FIG. 13.

When receiving the acquisition request message M11, the server 5a generates a response message M12 including data of the contents identified by the content name of /a/a. The server 5a outputs the generated response message M12 from the receiving port of the acquisition request message M11, and thus the response message M12 arrives at the transfer device A (arrow A31).

The receiving unit 43a of the transfer device A receives the response message M12 via the port #1. The transfer processing unit 51a stores the response message M12 in association with the content name of /a/a in the storage unit 60a. In addition, the transfer processing unit 51a determines a transfer destination by searching the pending interest table 62a using the content name in the response message M12 as the key. The content name of /a/a and the input port with port #2 are recorded in association with each other in the pending interest table 62a. Thus, the transfer processing unit 51a determines that the output port of the response message M12 is the port #2. Since the transmission unit 42a transmits the response message M12 from the port #2, the response message M12 is transferred to the transfer device E (arrow A32).

The receiving unit 43e of the transfer device E receives the response message M12 via the port #1. The transfer processing unit 51e stores the response message M12 in association with the content name of /a/a in the storage unit 60e. In addition, the transfer processing unit 51e determines a transfer destination by searching the pending interest table 62e using the content name in the response message M12 as the key. The content name of /a/a and the input port with port #2 are recorded in association with each other in the pending interest table 62e. Thus, the transfer processing unit 51e determines that the output port of the response message M12 is the port #2. Since the transmission unit 42e transmits the response message M12 from the port #2, the response message M12 is transferred to the transfer device D (arrow A33).

The receiving unit 43d of the transfer device D receives the response message M12 via the port #1. The transfer processing unit 51d stores the response message M12 in association with the content name of /a/a in the storage unit 60d. In addition, the transfer processing unit 51d searches the pending interest table 62d using the content name in the response message M12 as the key. The content name of /a/a and the input port with port #3 are recorded in association with each other in the pending interest table 62d. Thus, the transfer processing unit 51d determines that the output port of the response message M12 is the port #3. Since the transmission unit 42d transmits the response message M12 from the port #3, the response message M12 is transferred to the transfer device C (arrow A34).

The receiving unit 43c of the transfer device C receives the response message M12 via the port #4. The transfer processing unit 51c stores the response message M12 in association with the content name of /a/a in the storage unit 60c. In addition, the transfer processing unit 51c searches the pending interest table 62c using the content name in the response message M12 as the key. The content name of /a/a and the input port with port #5 are recorded in association with each other in the pending interest table 62c. Thus, the transfer processing unit 51c determines that the output port of the response message M12 is the port #5. Since the transmission unit 42c transmits the response message M12 from the port #5, the response message M12 is transferred to the communication device 80 (arrow A35). The communication device 80 is a request source (requester) of the contents identified by the content name of /a/a.

As described with reference to FIGS. 12 and 13, even when the paths used for acquiring multiple contents are integrated in the first embodiment, an acquisition request for contents arrives at the server 5 that stores the contents. Furthermore, the contents are transferred to the requester of the contents by using the pending interest table 62 by each transfer device 40. Thus, it is possible to perform transfer processing while reducing data which is stored by each transfer device 40 for using the transfer processing.

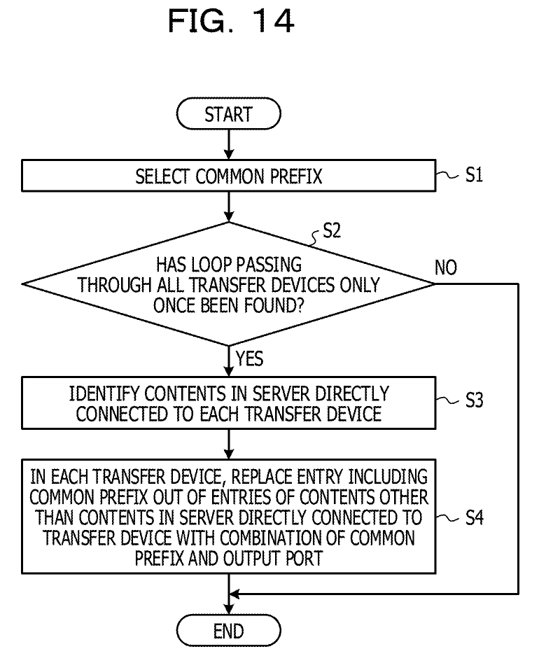

FIG. 14 is a flowchart illustrating example processing of the control device 10. In the example of FIG. 14, as the common identification information, the control device 10 determines a prefix (common prefix) which is in common in the content names that identify contents for which acquisition paths are to be integrated.

First, the acquisition processing unit 21 selects a common prefix using the content names that identify contents for which acquisition paths are to be integrated (51). The retrieval unit 22 determines whether or not a loop path passing through all the transfer devices 40 only once in the network is found (S2). In S2, when a loop path passing through all the transfer devices 40 only once in the network is not found, the retrieval unit 22 completes the processing (No in S2).

On the other hand, when a loop path passing through all the transfer devices 40 only once in the network is found, the retrieval unit 22 identifies the contents stored in the server directly connected to each of the transfer devices 40 in the network (Yes in S2, S3).

In S4, the retrieval unit 22 updates an entry in which a content name including the common prefix is registered, in the information transfer table information 32, the content name being an acquisition path for contents other than the contents stored in servers directly connected to the transfer devices 40. At this point, the retrieval unit 22 replaces an entry name and an output port in each entry in which a content name including the common prefix is registered with a combination of the common prefix and a port (output port) used for output to the loop path found in S2. Subsequently, the generation unit 23 generates a control packet for achieving consistency between information of the information transfer table information 32 after the update, and the information transfer table 61 in each transfer device 40. The generation unit 23 then transmits the control packet to the transfer device 40 via the communication unit 11. Consequently, in each transfer device 40, an entry of contents including the common prefix out of the entries of contents other than the contents stored in the server 5 directly connected to the transfer device 40 is replaced with a combination of the common prefix and an output port to the loop path.

As described above, when the paths used for acquiring multiple contents are integrated in the first embodiment, it is possible to perform transfer processing while reducing data which is stored by each transfer device 40 for using the transfer processing.

### Second Embodiment

In a second embodiment, an example of processing when a loop path using part of the transfer devices 40 in a network is found by the retrieval unit 22 will be described. Also in the second embodiment, the processing of the acquisition processing unit 21 is the same as the processing in the first embodiment. The retrieval unit 22 detects a loop path according to a request from the acquisition processing unit 21. In the following description, it is assumed that each of the transfer devices 40 in a network has stored the paths for acquiring content names of /a/a, /a/c, /a/d, and /a/e before integration processing.

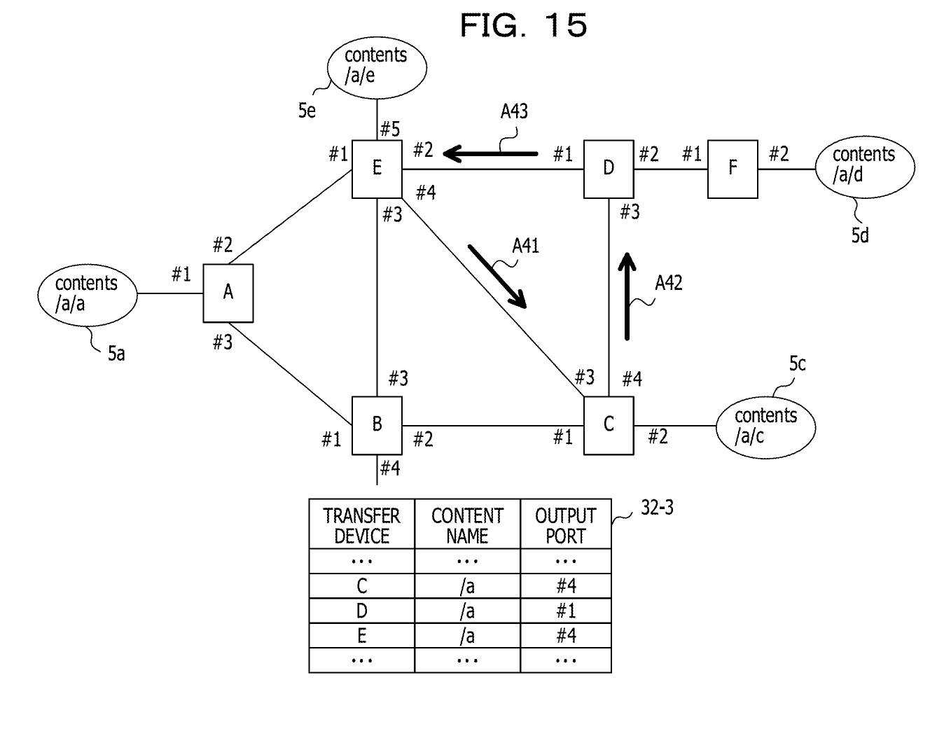

FIG. 15 is a diagram illustrating example retrieval of a loop in the second embodiment, and example update of the information transfer table information 32. In the example of FIG. 15, as indicated by arrows A41 to A43, it is assumed that a loop path including the transfer devices C to E is detected. Furthermore, it is assumed that /a is selected as the common identification information for the contents with the content names of /a/a, /a/c, /a/d, and /a/e.

For the transfer devices 40 included in the loop path, the retrieval unit 22 once replaces an entry for contents including the common identification information with a combination of the common identification information and an output port to the loop path in the information transfer table information 32. For instance, the retrieval unit 22 replaces each of the paths for the transfer devices C to E to acquire the content names of /a/a, /a/c, /a/d, and /a/e with a combination of the common identification information (/a) and an output port to the loop path, in each transfer device 40, in the information transfer table information 32. Thus, the information on the path of the transfer devices C to E is changed as follows, and information transfer table information 32-3 is obtained.

The transfer device C: content name=/a, output port=port #4

The transfer device D: content name=/a, output port=port #1

The transfer device E: content name=/a, output port=port #4

Next, for each transfer device 40 not included in the loop path, the retrieval unit 22 retrieves a path for communicating with one of the transfer devices 40 included in the loop path.

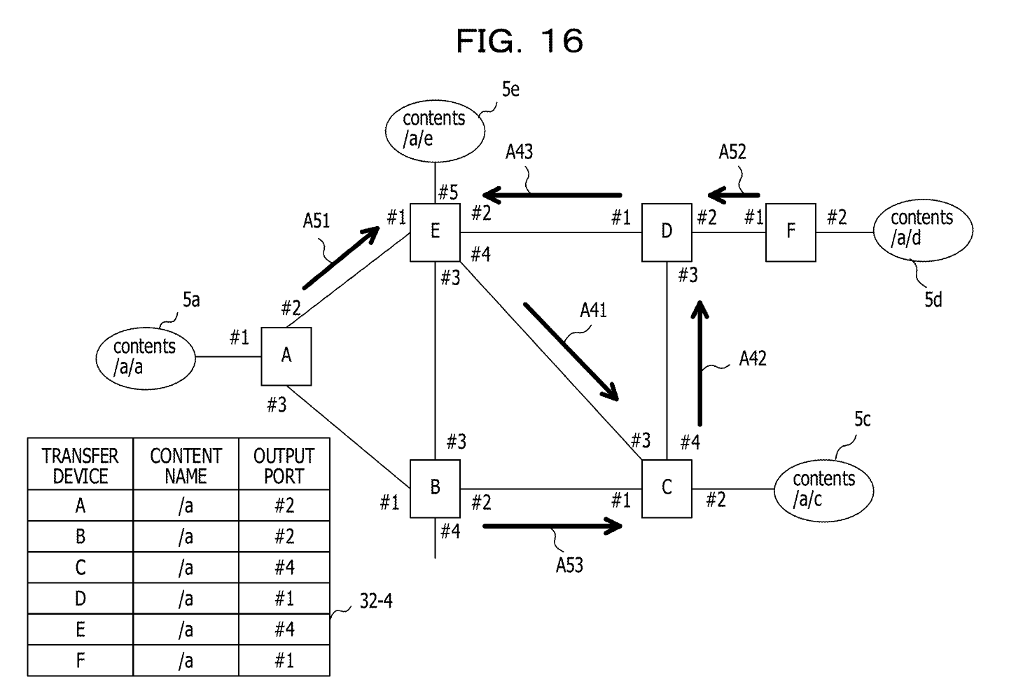

FIG. 16 is a diagram illustrating example update of the information transfer table information 32. Referring to FIG. 16, the processing performed by the retrieval unit 22 after the processing of FIG. 15 to retrieve a path for communicating with the transfer devices 40 included in the loop path for each of the transfer devices A, B, and F not included in the loop path will be described.

For the transfer device A, the retrieval unit 22 identifies that it is possible to communicate with the transfer device E included in the loop path by the path indicated by arrow A51. Then, the retrieval unit 22 replaces a path to contents including the common identification information on the transfer device A with a combination of the common identification information and an output port when communication with the transfer device E is performed in the information transfer table information 32-3 (FIG. 15). Consequently, the entry for the transfer device A is updated as follows:

The transfer device A: content name=/a, output port=port #2

Similarly, for the transfer device F, the retrieval unit 22 identifies that it is possible to communicate with the transfer device D included in the loop path by the path indicated by arrow A52. Then, the retrieval unit 22 replaces a path to contents including the common identification information on the transfer device F with a combination of the common identification information and an output port when communication with the transfer device D is performed in the information transfer table information 32-3. Consequently, the entry for the transfer device F is updated as follows:

The transfer device F: content name=/a, output port=port #1

In addition, for the transfer device B, the retrieval unit 22 identifies that it is possible to communicate with the transfer device C included in the loop path by the path indicated by arrow A53. Then, the retrieval unit 22 replaces a path to contents including the common identification information on the transfer device B with a combination of the common identification information and an output port when communication with the transfer device C is performed in the information transfer table information 32-3. Consequently, the entry for the transfer device B is updated as follows:

The transfer device B: content name=/a, output port=port #2

Information transfer table information 32-4 is an example of the information transfer table information 32 which is obtained by performing update processing using paths (arrows A51 to A53) to arrive at the transfer devices 40 included in the loop path for the transfer devices A, B, and F.

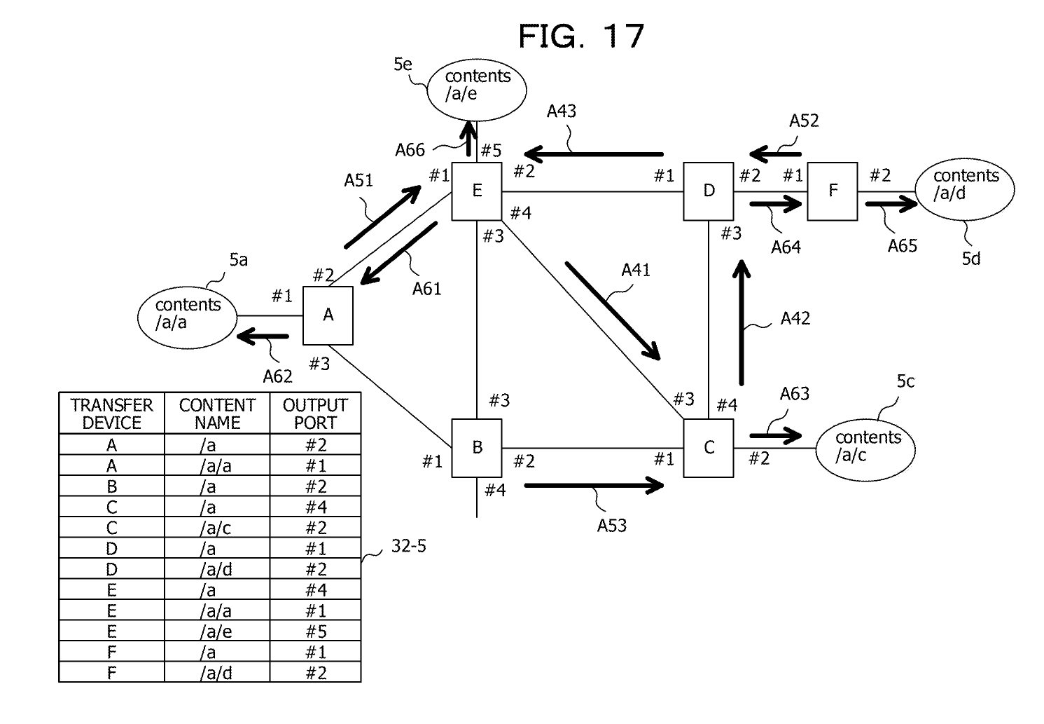

FIG. 17 is a diagram illustrating example update of the information transfer table information 32. After the processing described with reference to FIGS. 15 and 16, the retrieval unit 22 retrieves a path from each transfer device 40 in the loop path to server 5 that stores contents in the network.

The retrieval unit 22 identifies that it is possible to communicate with the server 5a which stores the contents with the content name of /a/a from the transfer device E included in the loop path by the path indicated by arrows A61, A62. Then, the retrieval unit 22 adds the path indicated by the arrow A61 to the information transfer table information 32-4, the path being used by the transfer device E for acquisition of contents with the content name of /a/a. In addition, the retrieval unit 22 adds the path indicated by the arrow A62, the path being used by the transfer device A for acquisition of contents with the content name of /a/a. Consequently, the entries for the transfer devices A and E are updated as follows:

The transfer device A: content name=/a, output port=port #2

The transfer device A: content name=/a/a, output port=port #1

The transfer device E: content name=/a, output port=port #4

The transfer device E: content name=/a/a, output port=port #1

Next, it is assumed that the retrieval unit 22 identifies that it is possible to communicate with the server 5c which stores the contents with the content name of /a/c from the transfer device C included in the loop path by the path indicated by arrow A63. Then, the retrieval unit 22 adds the path indicated by the arrow A63 to the information transfer table information 32-4, the path being used by the transfer device C for acquisition of contents with the content name of /a/c. Consequently, the entries for the transfer device C updated as follows:

The transfer device C: content name=/a, output port=port #4

The transfer device C: content name=/a/c, output port=port #2

The retrieval unit 22 identifies that it is possible to communicate with the server 5d which stores the contents with the content name of /a/d from the transfer device D included in the loop path by the path indicated by arrows A64, A65. Then, the retrieval unit 22 adds the path indicated by the arrow A64 to the information transfer table information 32-4, the path being used by the transfer device D for acquisition of contents with the content name of /a/d. In addition, the retrieval unit 22 adds the path indicated by the arrow A65, the path being used by the transfer device F for acquisition of contents with the content name of /a/d. Consequently, the entries for the transfer devices D and F are updated as follows:

The transfer device D: content name=/a, output port=port #1

The transfer device D: content name=/a/d, output port=port #2

The transfer device F: content name=/a, output port=port #1

The transfer device F: content name=/a/d, output port=port #2

In addition, it is assumed that the retrieval unit 22 identifies that it is possible to communicate with the server 5e which stores the contents with the content name of /a/e from the transfer device E included in the loop path by the path indicated by arrow A66. Then, the retrieval unit 22 adds the path indicated by the arrow A66 to the information transfer table information 32-4, the path being used by the transfer device E for acquisition of contents with the content name of /a/e. Consequently, the entries for the transfer device E updated as follows:

The transfer device E: content name=/a, output port=port #4

The transfer device E: content name=/a/a, output port=port #1

The transfer device E: content name=/a/e, output port=port #5

Information transfer table information 32-5 is an example of the information transfer table information 32 obtained when the paths (arrows A61 to A66) for accessing each content from the transfer devices 40 included in the loop path are added.

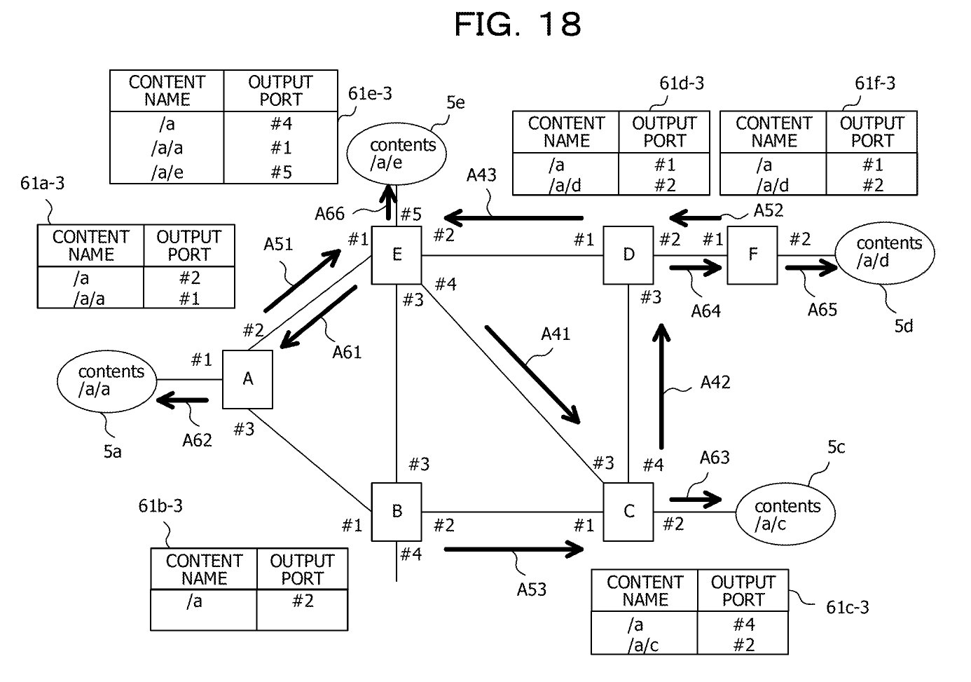

FIG. 18 is a diagram illustrating example retrieval of a loop in the second embodiment, and example update of the information transfer table 61. By the processing illustrated in FIGS. 15 to 17, the update of the information transfer table information 32 for integration of paths is completed.

Then, for each transfer device 40, the generation unit 23 generates a control packet for notifying of path information applied to the transfer device 40, in accordance with the information transfer table information 32-5 (FIG. 17). The generation unit 23 then performs transmission processing for the control packet. Each transfer device 40 updates the information transfer table 61 in accordance with the control packet. Thus, the transfer device A stores entries for the content names of /a and /a/a as indicated in the information transfer table 61a-3 by the update processing. The transfer device B stores an entry for the content name of /a as indicated in the information transfer table 61b-3 by the update processing. The transfer device C stores entries for the content names of /a and /a/c as indicated in the information transfer table 61c-3 by the update processing. The transfer device D stores entries for the content names of /a and /a/d as indicated in the information transfer table 61d-3 by the update processing. The transfer device E stores entries for the content names of /a, /a/a, and /a/e as indicated in the information transfer table 61e-3 by the update processing. Furthermore, the transfer device F stores entries for the content names of /a and /a/d as indicated in the information transfer table 61f-3 by the update processing.

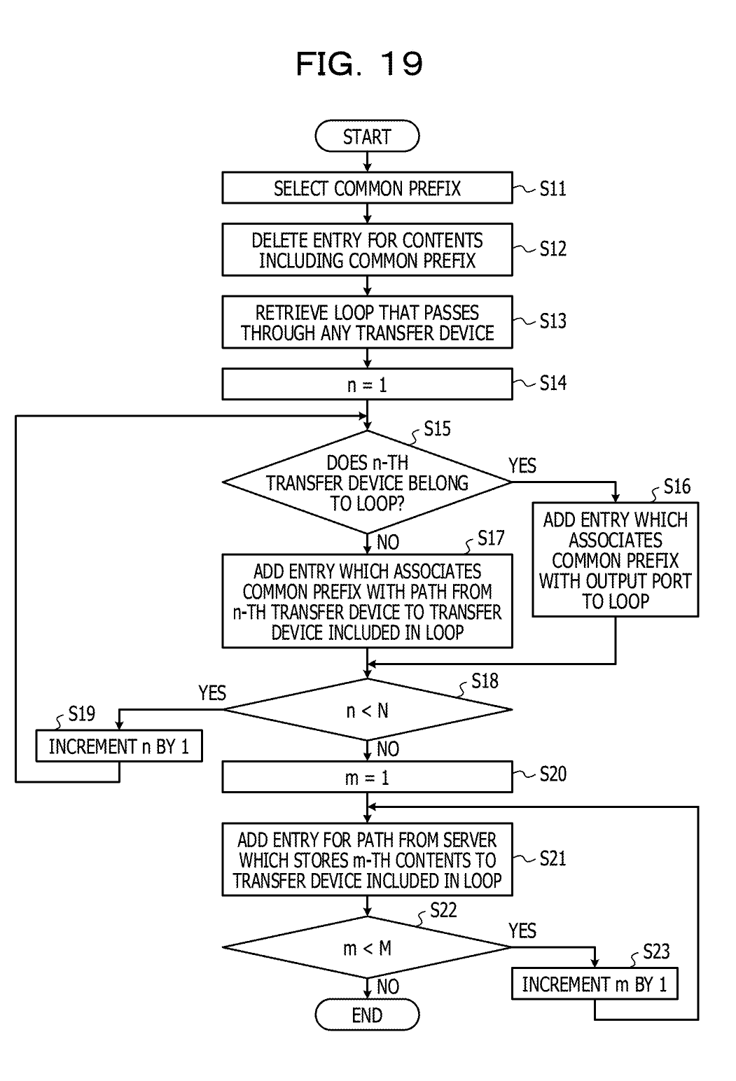

FIG. 19 is a flowchart illustrating example processing of the control device 10. Also in the example of FIG. 19, the control device 10 determines a common prefix as the common identification information. In FIG. 19, constants M, N and variables m, n are used. The constant N is the total number of the transfer devices 40 included in the network. The constant M is the total number of contents which are accessible from the network and identifiable by content names including a common prefix. Furthermore, the variable m is used for counting contents for which a path is retrieved. The variable n is used for counting contents for which a path is retrieved. FIG. 19 illustrates an example of processing, and the step of the processing may be changed according to implementation. For instance, the order of S12 and S13 may be changed.

First, the acquisition processing unit 21 selects a common prefix using the content names that identify contents for which acquisition paths are to be integrated (S11). For each transfer device 40 in the network, the retrieval unit 22 deletes entries for the contents including the common prefix from the information transfer table information 32 (S12). In addition, the retrieval unit 22 retrieves a loop that passes through any transfer device 40 included in the network (S13). The retrieval unit 22 sets the variable n to 1 (S14).

The retrieval unit 22 determines whether the n-th transfer device 40 belongs to the loop retrieved in S13 (S15). When the n-th transfer device 40 belongs to the loop, for the n-th transfer device 40, the retrieval unit 22 adds an entry to the information transfer table information 32, the entry associating the common prefix with an output port to the loop (Yes in S15, S16). On the other hand, when the n-th transfer device 40 does not belong to the loop, the retrieval unit 22 retrieves a path from the n-th transfer device 40 to a transfer device 40 included in the loop (No in S15). For the n-th transfer device 40, the retrieval unit 22 adds an entry to the information transfer table information 32, the entry associating the common prefix with the path from the n-th transfer device 40 to a transfer device 40 included in the loop (S17). When the processing in S16 or S17 is completed, the retrieval unit 22 compares the variable n with the constant N (S18). When the variable n is less than the constant N, the retrieval unit 22 increments the variable n by 1, and the flow returns to S15 (Yes in S18, S19).

When the variable n exceeds the constant N-1, as described with reference to FIG. 16, for each transfer device 40 in the network, an entry associated with the common prefix has been recorded in the information transfer table information 32 (No in S18). Thus, the retrieval unit 22 sets the variable m to 1, and starts to retrieve a path for accessing each content from a transfer device belonging to the loop (S20).

The retrieval unit 22 adds an entry to the information transfer table information 32, the entry for a path from a server 5 which stores the m-th contents to the transfer device 40 included in the loop (S21). Subsequently, the retrieval unit 22 compares the variable m with the constant M (S22). When the variable m is less than the constant M, the retrieval unit 22 increments the variable m by 1, and the flow returns to S21 (Yes in S22, S23). On the other hand, when the variable m exceeds the constant M-1, the paths used by the transfer devices 40 in the loop for obtaining all the contents identified by content names including the common prefix have been recorded in the information transfer table information 32 (No in S22). Thus, the retrieval unit 22 completes the update of the information transfer table information 32.

Subsequently, as described with reference to FIG. 18, the generation unit 23 generates a control packet that requests update of the information transfer table 61 stored by each transfer devices 40 in the network consistently with the information transfer table information 32, and transmits the control packet to the transfer device 40. Thus, according to the second embodiment, it is possible to integrate the information on the path used for acquiring part of the contents using a loop path that passes through part of the transfer devices 40 in the network. Consequently, it is possible to reduce the volume of information stored by each individual transfer device 40 for transfer processing.

The second embodiment is effective when a loop path that passes through all the transfer devices 40 only once in the network is not found, or it is difficult to find a loop because the network size is large. In addition, the second embodiment is effective even when a loop path that passes through all the transfer devices 40 only once in the network is found, delay in message transfer occurs because the loop path is large.

### Third Embodiment

In a third embodiment, an embodiment, in which a transfer device autonomously updates the information transfer table 61, will be described.

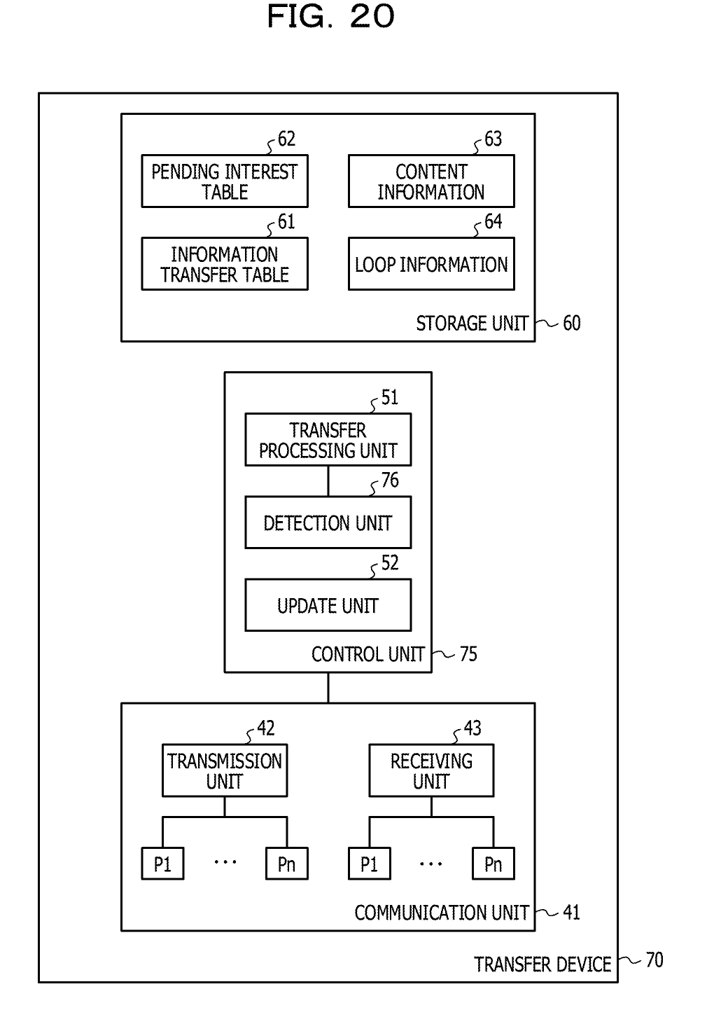

FIG. 20 is a diagram illustrating an example configuration of a transfer device 70 according to the third embodiment. The transfer device 70 includes a communication unit 41, a control unit 75, and a storage unit 60. The control unit 75 includes a transfer processing unit 51, a detection unit 76, and an update unit 77. The storage unit 60 stores information transfer table 61, pending interest table 62, content information 63, and loop information 64.

Similarly to the content information 33 (FIG. 5) stored by the control device 10, the content information 63 associates the content name of contents accessible by each device in the network with the information on the transfer device connected to server 5 that stores the contents. The loop information 64 identifies a port connected to the loop path out of the ports included in the transfer device 70. The loop information 64 is notified from the control device 10. The information transfer table 61 and the pending interest table 62 are similar to the table stored by the transfer device 40.

The detection unit 76 pre-stores a threshold value, and when the number of entries in the information transfer table 61 exceeds the threshold value, the detection unit 76 requests the update unit 77 to integrate the paths. The update unit 77 performs integration processing of the paths using the information transfer table 61, the content information 63, and the loop information 64. The details of the processing of the detection unit 76 and the update unit 77 will be described later. Also in the transfer device 70, the processing of the transfer processing unit 51 and the communication unit 41 is similar to the processing of the transfer device 40.

The hardware configuration of the transfer device 70 is also as illustrated in FIG. 7. In the transfer device 70, the processor 101 operates as the control unit 75, and the memory 102 operates as the storage unit 60. Furthermore, the communication unit 41 is implemented by the network connection device 104.

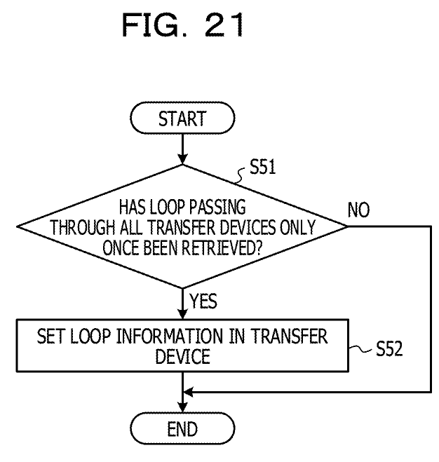

FIG. 21 is a flowchart illustrating example processing of the control device 10. The retrieval unit 22 in the control device 10 determines whether a loop passing through all the transfer devices 70 only once in the network has been retrieved (S51). The processing in S51 is the same as the retrieval of a loop path in the first embodiment. When a loop passing through all the transfer devices 70 only once in the network is not obtained, the control device 10 completes the processing without notifying the transfer device 70 of the loop information 64 (No in S51).

When a loop passing through all the transfer devices 70 only once in the network is obtained, the generation unit 23 generates a packet for notifying each transfer device 70 of an output port to the loop path, in the transfer device 70, as the loop information 64 (Yes in S51). The generation unit 23 sets the loop information 64 in the transfer device 70 by transmitting a packet for notifying the transfer device 70 of the loop information 64 via the communication unit 11 (S52).

For instance, it is assumed that port #3 is an output port when the loop path is used in a transfer device 70a. Then, the generation unit 23 notifies the transfer device 70a that the port #3 is an output port when the loop path is used. The transfer processing unit 51 of the transfer device 70a obtains the packet via the receiving unit 43. The transfer processing unit 51 stores information as the loop information 64 in the storage unit 60 using the obtained packet, the information indicating that the output port when the loop path is used is the port #3.

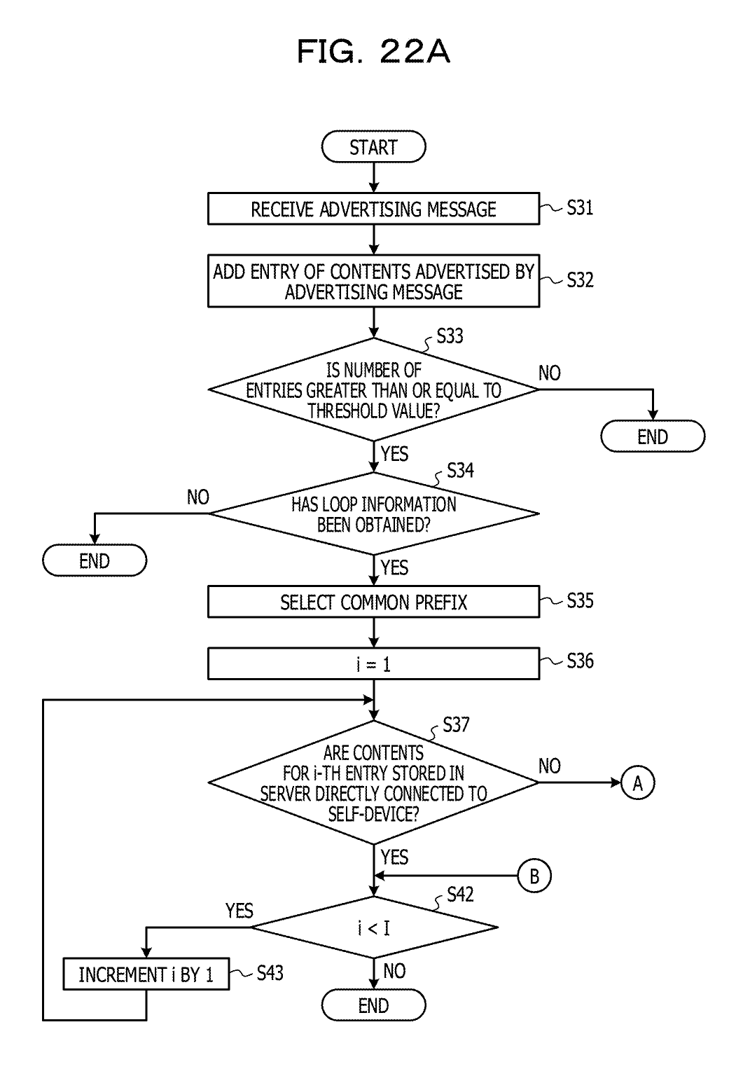

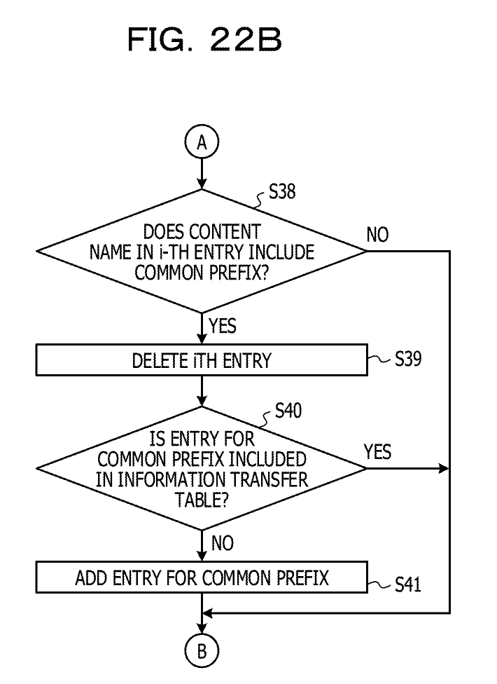

FIGS. 22A and 22B are flowcharts illustrating example processing of the transfer device 70. In FIGS. 22A and 22B, constant I is the total number of entries in the information transfer table 61 at the start of integration processing, and variable i is used for counting entry for which processing is to be performed. FIGS. 22A and 22B illustrate example processing, and the order of processing may be changed according to implementation. For instance, the order of S33 to S35 may be changed in any manner.

When contents are added to a network, an advertising message for notifying of the content name of the contents is transmitted from server 5 which stores the contents. The advertising message is transmitted by a protocol such as Named Data Link State Routing protocol (NLSR), for instance. The receiving unit 43 receives the advertising message (S31). The update unit 77 adds an entry of the contents advertised by the advertising message to the information transfer table 61 (S32). In addition, when the advertising message includes information on a transfer device 70 connected to server 5 which stores the contents advertised by the advertising message, the update unit 77 updates the content information 63 using the advertising message.

The detection unit 76 determines whether the number of entries in the information transfer table 61 is greater than or equal to a threshold value (S33). When the number of entries in the information transfer table 61 is less than the threshold value, the detection unit 76 completes the processing (No in S33).

When the number of entries in the information transfer table 61 is greater than or equal to the threshold value, the detection unit 76 requests the update unit 77 to integrate the path information (Yes in S33). When integration of the path information is requested from the detection unit 76, the update unit 77 determines whether loop information 64 has been obtained from the control device 10 (S34). When the loop information 64 is not obtained from the control device 10, the update unit 77 completes the processing (No in S34).

When the loop information 64 is obtained from the control device 10, the update unit 77 selects a common prefix using the information transfer table 61 (S35). The selection processing for the common prefix will be described later. The update unit 77 sets the variable i to 1 (S36). The update unit 77 determines whether the contents for the i-th entry are stored in the server directly connected to the self-device (S37).

When the contents for the i-th entry is not stored in the server directly connected to the self-device, the update unit 77 determines whether the content name in the i-th entry includes a common prefix (No in S37, S38). When the content name in the i-th entry includes the common prefix, the update unit 77 deletes the i-th entry from the information transfer table 61 (Yes in S38, S39). Subsequently, the update unit 77 determines whether an entry for the common prefix is included in the information transfer table 61 (S40). When an entry for the common prefix is not included in the information transfer table 61, the update unit 77 adds the entry for the common prefix to the information transfer table 61 (No in S40, S41). Here, an entry for the common prefix is a combination of the common prefix and the port number notified as the loop information 64. On the other hand, when an entry for the common prefix is already included in the information transfer table 61, the update unit 77 does not add the entry for the common prefix to the information transfer table 61 (Yes in S40).

After the processing in S41 or when it is determined in S40 that the entry for the common prefix is included in the information transfer table 61, the update unit 77 compares the variable i with the constant I (S42). When the variable i is less than the constant I, the update unit 77 increments the variable i by 1, and the flow returns to S37 (Yes in S42, S43). On the other hand, when the variable i is greater than or equal to the constant I, the processing is completed because the processing for all the entries in the information transfer table 61 is completed (No in S42).

When the contents in the i-th entry are stored in the server directly connected to the self-device, contents are acquired using the information on the i-th entry even after integration of the path information (Yes in S37). Thus, the update unit 77 does not delete the i-th entry from the information transfer table 61. When determination of Yes is made in S37, the processing in and after S42 is performed.

Furthermore, even when the contents in the i-th entry are not stored in the server directly connected to the self-device, the common prefix may not be included in the content name in the i-th entry (No in S38). In this case, the processing in and after S42 is performed because the i-th entry is not a path to be integrated using the common prefix.

In this manner, in the third embodiment, when the entry in the information transfer table 61 exceeds a threshold value and the loop information 64 is obtained, the transfer device 70 uses the common prefix to integrate the path to the contents not stored in server 5 connected to the self-device. At this point, an entry having a content name including the common prefix out of the entries in the information transfer table 61 is replaced with a combination of the common prefix and an port recorded as the loop information 64 by the integration processing.

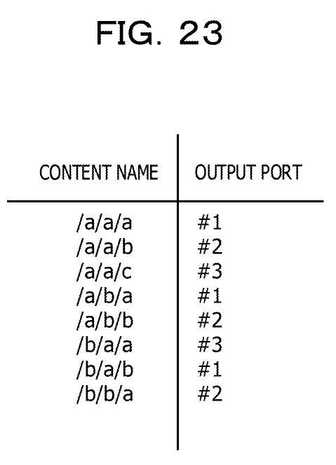

FIG. 23 is a diagram illustrating an example of the information transfer table 61. Hereinafter, a method of selecting a common prefix will be described with reference to FIG. 23. In a content name, separator of a path is indicated by slash (/). Hereinafter, the number of portions separated by a slash is referred to as “level number” of a prefix. For instance, /a has a level number of 1, and /a/a has a level number of 2. It is assumed that the update unit 77 pre-stores a level number used when a common prefix is determined. When selecting a common prefix, the update unit 77 selects a prefix having a largest number of entries in the information transfer table 61 out of prefixes with a predetermined level number N, as the common prefix. When the information transfer table 61 is as illustrated in FIG. 23, and the level number included in the common prefix is 2, the number of entries including a prefix of /a/a is 3, the number of entries including a prefix of /a/b is 2, and the number of entries including a prefix of /b/a is 2. Furthermore, the number of entries including a prefix of /b/b is 1. Thus, the update unit 77 selects the prefix of /a/a as the common prefix. In this case, integration processing is to be performed on the paths which are used for acquiring the contents identified by the content names of /a/a/a, /a/a/b, and /a/a/c.

As described in the third embodiment, when the transfer device 70 selects a common prefix or autonomously updates the information transfer table 61, a processing load on the control device 10 is reduced as compared with the first and second embodiments.

### Fourth Embodiment

In a fourth embodiment, an example of processing when multiple loop paths using part of the transfer devices 40 in a network is found by the retrieval unit 22 will be described. Also in the fourth embodiment, it is assumed that the processing of the acquisition processing unit 21 is the same as the processing in the first to third embodiments and the retrieval unit 22 detects a loop path according to a request from the acquisition processing unit 21. In the following description, similarly to the first to third embodiments, it is assumed that each of the transfer devices 40 in a network has stored the paths for acquiring content names of /a/a, /a/c, /a/d, and /a/e before integration processing.

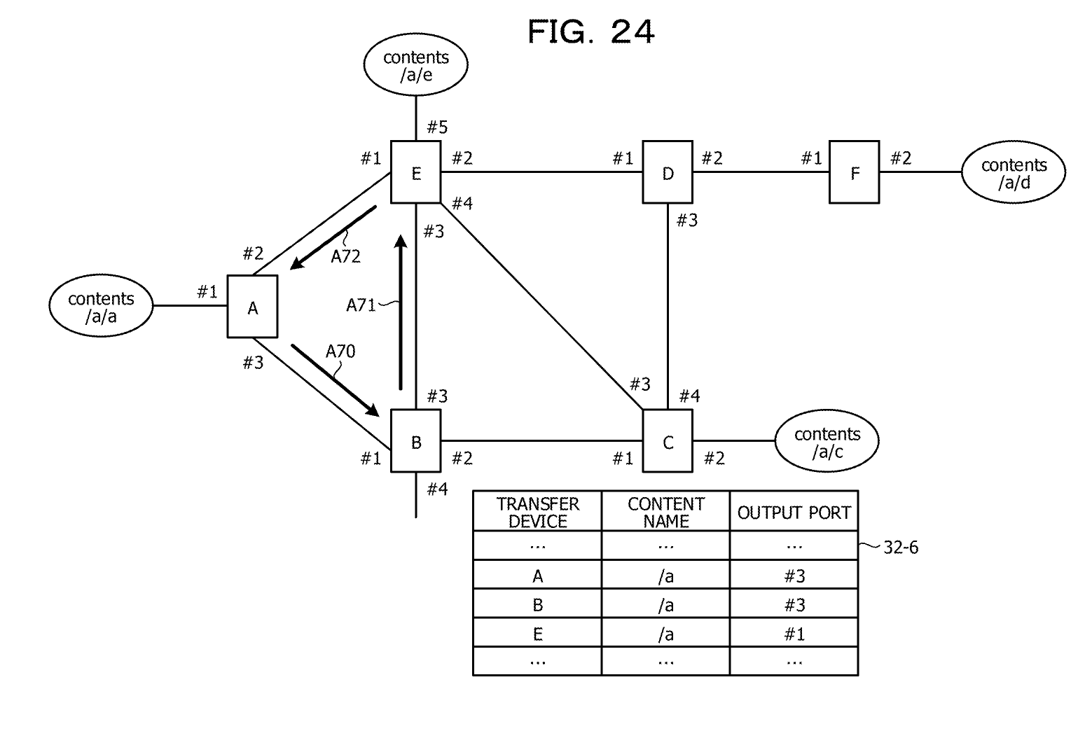

FIG. 24 is a diagram illustrating example retrieval of a loop in the fourth embodiment, and example update of the information transfer table information 32. In the example of FIG. 24, as indicated by arrows A70 to 72, it is assumed that a loop path including the transfer devices A, B, and E is detected. Furthermore, it is assumed that /a is selected as the common identification information for the contents with the content names of /a/a, /a/c, /a/d, and /a/e.

For the transfer devices 40 included in the loop path, the retrieval unit 22 once replaces an entry for contents including the common identification information with a combination of the common identification information and an output port to the loop path in the information transfer table information 32. For instance, the retrieval unit 22 replaces each of the paths for the transfer devices A, B, and E to E to acquire the content names of /a/a, /a/c, /a/d, and /a/e with a combination of the common identification information (/a) and an output port to the loop path, in each transfer device 40, in the information transfer table information 32. Thus, the information on the path of the transfer devices A, B, and E is changed as follows, and information transfer table information 32-6 is obtained.

The transfer device A: content name=/a, output port=port #3

The transfer device B: content name=/a, output port=port #3

The transfer device E: content name=/a, output port=port #1

Next, for each transfer device 40 not included in the loop path, the retrieval unit 22 retrieves a path for communicating with one of the transfer devices 40 included in the loop path.

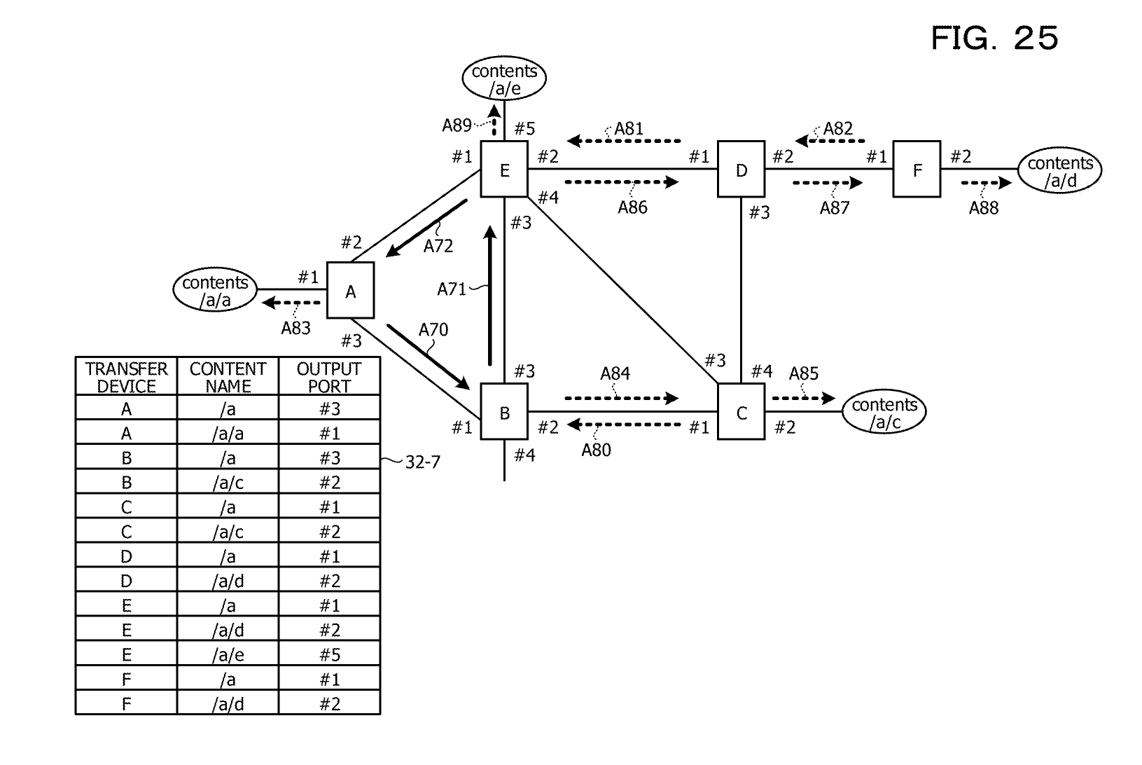

FIG. 25 is a diagram illustrating example update of the information transfer table information 32. Referring to FIG. 25, for the transfer devices C, D, and F, the processing to retrieve a path for communicating with the transfer devices 40 included in the loop path will be described.

For the transfer device C, the retrieval unit 22 identifies that it is possible to communicate with the transfer device B included in the loop path by the path indicated by arrow A80. Then, the retrieval unit 22 replaces a path to contents including the common identification information on the transfer device C with a combination of the common identification information and an output port when communication with the transfer device B is performed in the information transfer table information 32-6 (FIG. 24). Consequently, the entry for the transfer device C is updated as follows. Here, although generation of a path from the transfer device C to the transfer device B has been described, a path from the transfer device C to the transfer device E may be generated.

The transfer device C: content name=/a, output port=port #1

Similarly, for the transfer device D, the retrieval unit 22 identifies that it is possible to communicate with the transfer device E included in the loop path by the path indicated by arrow A81. Then, the retrieval unit 22 replaces a path to contents including the common identification information on the transfer device D with a combination of the common identification information and an output port when communication with the transfer device E is performed in the information transfer table information 32-6 (FIG. 24). Consequently, the entry for the transfer device D is updated as follows. Here, although a path from the transfer device D via the transfer device C may be selected, as an example, a path having fewer steps is preferentially selected.

The transfer device D: content name=/a, output port=port #1

Furthermore, the retrieval unit 22 identifies that it is possible for the transfer device F to communicate with the loop path via the transfer device D in which the path to the loop path is established as indicated by arrow A82. Then, the retrieval unit 22 replaces a path to contents including the common identification information on the transfer device F with a combination of the common identification information and an output port when communication with the transfer device D is performed in the information transfer table information 32-6 (FIG. 24). Consequently, the entry for the transfer device F is updated as follows:

The transfer device F: content name=/a, output port=port #1

Subsequently, the retrieval unit 22 retrieves a path from each transfer device 40 in the loop path to server 5 that stores contents in the network.

Specifically, the retrieval unit 22 identifies that it is possible to communicate with the server 5a which stores the contents with the content name of /a/a from the transfer device A included in the loop path by the path indicated by arrow A83. Then, the retrieval unit 22 adds the path indicated by the arrow A83 to the information transfer table information 32-6, the path being used by the transfer device A for acquisition of contents with the content name of /a/a. Consequently, the entry for the transfer device A is updated as follows:

The transfer device A: content name=/a, output port=port #3

The transfer device A: content name=/a/a, output port=port #1

Next, the retrieval unit 22 identifies that it is possible to communicate with the server 5c which stores the contents with the content name of /a/c from the transfer device B included in the loop path by the path indicated by arrows A84, A85. Then, the retrieval unit 22 adds the path indicated by the arrow A84 to the information transfer table information 32-6, the path being used by the transfer device B for acquisition of contents with the content name of /a/c. In addition, the retrieval unit 22 adds the path indicated by the arrow A85, the path being used by the transfer device C for acquisition of contents with the content name of /a/c. Consequently, the entries for the transfer devices B and C are updated as follows:

The transfer device B: content name=/a, output port=port #3

The transfer device B: content name=/a/c, output port=port #2

The transfer device C: content name=/a, output port=port #1

The transfer device C: content name=/a/c, output port=port #2

Similarly, the retrieval unit 22 identifies that it is possible to communicate with the server 5d which stores the contents with the content name of /a/d from the transfer device E included in the loop path by the path indicated by arrows A86, A87, and A88. Then, the retrieval unit 22 adds the paths indicated by the arrows A86 and A87 to the information transfer table information 32-6, the path being used by the transfer devices E and D for acquisition of contents with the content name of /a/d, respectively. In addition, the retrieval unit 22 adds the path indicated by the arrow A88, the path being used by the transfer device F for acquisition of contents with the content name of /a/d. Consequently, the entries for the transfer devices E, D, and F are updated as follows:

The transfer device E: content name=/a, output port=port #1

The transfer device E: content name=/a/d, output port=port #2

The transfer device D: content name=/a, output port=port #1

The transfer device D: content name=/a/d, output port=port #2

The transfer device F: content name=/a, output port=port #1

The transfer device F: content name=/a/d, output port=port #2

The retrieval unit 22 identifies that it is possible to communicate with the server 5e which stores the contents with the content name of /a/e from the transfer device E included in the loop path by the path indicated by arrow A89. Then, the retrieval unit 22 adds the path indicated by the arrow A89 to the information transfer table information 32-6, the path being used by the transfer device E for acquisition of contents with the content name of /a/e. Consequently, the entries for the transfer device E updated as follows:

The transfer device E: content name=/a, output port=port #1

The transfer device E: content name=/a/d, output port=port #2

The transfer device E: content name=/a/e, output port=port #5

In addition, information transfer table information 32-7 is an example of the information transfer table information 32 obtained when the paths (arrows A80 to A89) for accessing each content from the transfer devices 40 included in the loop path are added.

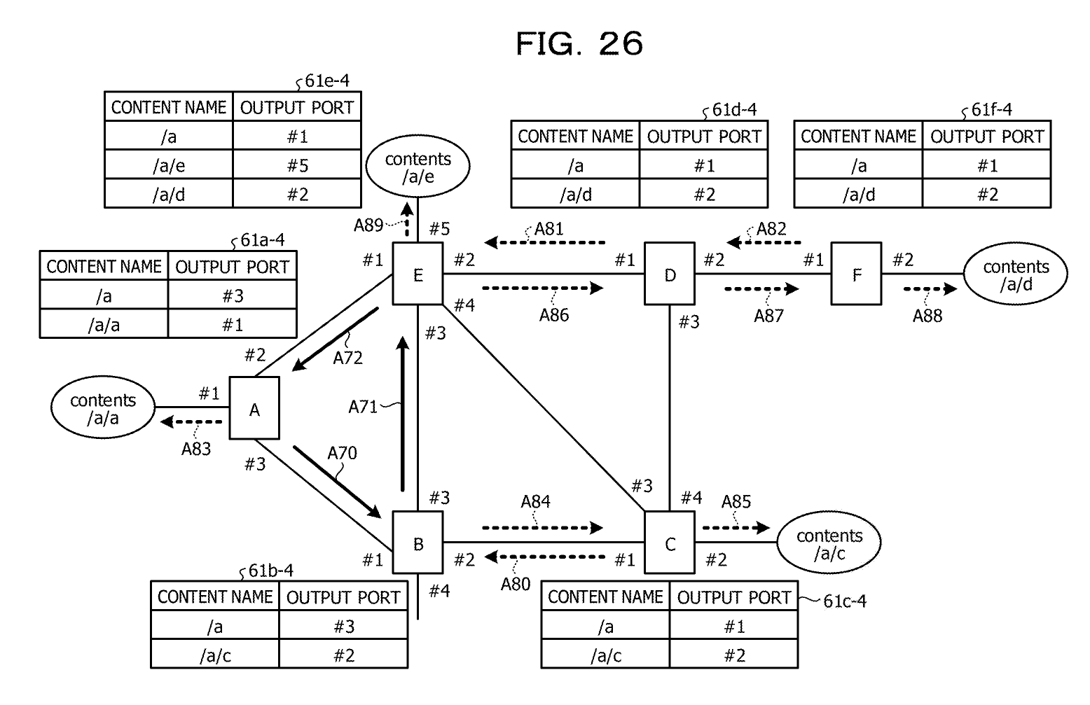

FIG. 26 is a diagram illustrating example retrieval of a loop in the fourth embodiment, and example update of the information transfer table 61. By the processing illustrated in FIGS. 24 and 25, the update of the information transfer table information 32 for integration of paths is completed.

Then, for each transfer device 40, the generation unit 23 generates a control packet for notifying of path information applied to the transfer device 40, in accordance with the information transfer table information 32-7 (FIG. 25). The generation unit 23 then performs transmission processing for the control packet. Each transfer device 40 updates the information transfer table 61 in accordance with the control packet. Thus, the transfer device A stores entries for the content names of /a and /a/a as indicated in the information transfer table 61a-4 by the update processing. The transfer device B stores an entry for the content name of /a and a/c as indicated in the information transfer table 61b-4 by the update processing. The transfer device C stores entries for the content names of /a and /a/c as indicated in the information transfer table 61c-4 by the update processing. The transfer device D stores entries for the content names of /a and /a/d as indicated in the information transfer table 61d-4 by the update processing. The transfer device E stores entries for the content names of /a, /a/e, and /a/d as indicated in the information transfer table 61e-4 by the update processing. Furthermore, the transfer device F stores entries for the content names of /a and /a/d as indicated in the information transfer table 61f-4 by the update processing.

In this state, any loop is added in a fourth embodiment. Specifically the retrieval unit 22 adds any loop, calculates a path so that transferring may be performed using a common prefix (common identification information), and determines a total of entries T′. When T′ is greater than T, the retrieval unit 22 select another loop. Here, when T′ is still greater than T even after selection K times which is a threshold value, the retrieval unit 22 completes selection, and substitutes T for the value of T′ and adds another loop. When a new loop is unable to be added, the retrieval unit 22 completes the selection.

For instance, in addition to the loop of transfer device A ->transfer device B ->transfer device E ->transfer device A, the retrieval unit 22 adds the loop of transfer device C ->transfer device D ->transfer device E ->transfer device C. The retrieval unit 22 then adds an entry to each of the loops to allow circulation around the loop in one direction using the common identification information (/a). Thus, the retrieval unit 22 sets output ports #1 and #4 to the transfer device E which is a connection point of the two loops to allow transfer to the two loops. For instance, when a content request message is received from port #3 in the transfer device E, the content request message is copies and outputted to the port #1 and the port #4.

Next, similarly to the first loop, for a node not belonging to the loop, the retrieval unit 22 finds a path to any node included in the loop, and adds an entry to the information transfer table information, the entry for transferring to the transfer device included in the loop using selected common identification information (/a). The retrieval unit 22 then finds a path from each contents having the common identification information any transfer device included in the loop, and adds an entry to the information transfer table information, the entry for transferring to the contents from the transfer device included in the loop. Subsequently, an entry, for which the number of entries is not reduced by further adding a loop, provides a final solution, and the control device 10 updates the entry for each transfer device.

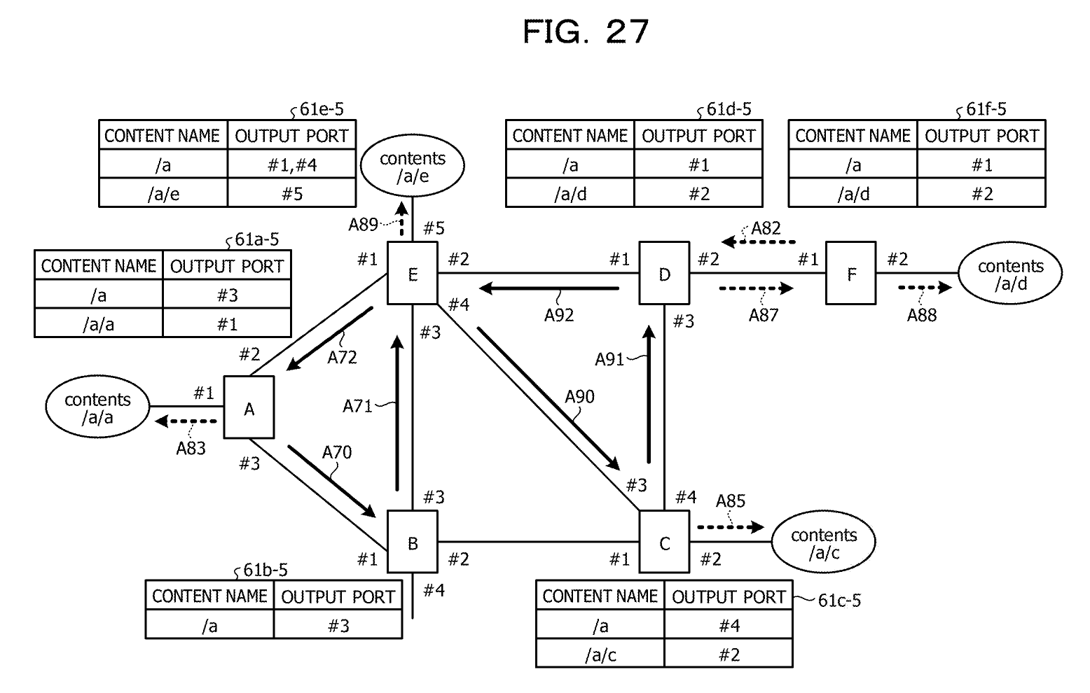

A specific example will be described using FIG. 27. FIG. 27 is a diagram illustrating addition control for a loop path. As illustrated in FIG. 27, it is assumed that the loop path, which is indicated by arrows A90, A91, and A92 and includes the transfer devices E, C, and D, is detected. The control device 10 then identifies a combination of common identification information and an output port to the loop path, and updates the path of each relevant transfer device 40 by the combination.

For instance, the retrieval unit 22 rewrites the information transfer table 61 of each of the transfer device E, the transfer device C, and the transfer device D so that a loop is formed using the common identification information (/a). Particularly, the retrieval unit 22 adds the following paths to the entries of the information transfer table information 32.

The transfer device E: content name=/a, output port=port #4

The transfer device C: content name=/a, output port=port #4

The transfer device D: content name=/a, output port=port #1

Accordingly, the first loop of the transfer devices A-B-E and the second loop of the transfer devices E-C-D in which a loop is formed using the same common identification information (/a), and are connected to each other via the transfer device E. Thus, the retrieval unit 22 deletes the following redundant paths from already generated path information (each information transfer table 61 in FIG. 26). Specifically, from the transfer device B to the transfer device C, the transfer device E may be passed through by a loop path of the common identification information (/a) not by a direct path. Thus, the paths below do not have to be provided. Similarly, from the transfer device C to the transfer device B, the transfer device E may be passed through by a loop path of the common identification information (/a) not by a direct path. Thus, the paths below do not have to be provided. From the transfer device E to the transfer device D, a path is connected by a new loop path of the common identification information (/a). Thus, the paths below do not have to be provided. Similarly, from the transfer device D to the transfer device E, a path is connected by a new loop path of the common identification information (/a). Thus, the following existing paths generated in FIGS. 25 and 26 do not have to be provided.

The transfer device B: content name=/a/c, output port=port #2

The transfer device C: content name=/a, output port=port #1

The transfer device E: content name=/a/d, output port=port #2

The transfer device D: content name=/a, output port=port #1

Subsequently, the control device 10 generates a control packet for the addition of a new path and the deletion of an existing path, and transmits the control packet to each transfer device 40, then each transfer device 40 updates the information transfer table 61 in accordance with the control packet.

For instance, the transfer device A does not update the information transfer table 61a-4, and stores entries for the content names of /a and /a/a as indicated in the information transfer table 61a-5 by the update processing. The transfer device B deletes the entry for the content name of /a/c, and stores an entry for the content name of /a as indicated in the information transfer table 61b-5 by the update processing.

The transfer device C deletes the entry for the content name of /a (output port #1), and stores an entry for the content name of /a (output port #4) as indicated in the information transfer table 61c-5 by the update processing. As a consequence, the transfer device C stores entries for the content names of /a and /a/c. The transfer device D adds an entry and deletes the entry each for the content name of /a as indicated in the information transfer table 61d-5 by the update processing. As a consequence, the transfer device D stores entries for the content names of /a and /a/d.

The transfer device E deletes the entry for the content name of /a/d, and adds an entry for the content name of /a (output port #4) as indicated in the information transfer table 61e-5 by the update processing. As a consequence, the transfer device E stores entries for the content names of /a and /a/e. Furthermore, the transfer device F stores entries for the content names of /a and /a/d as indicated in the information transfer table 61f-5 by the update processing.

As described above, when the number of loop paths illustrated in FIG. 26 is 1, the total of paths stored by the transfer devices 40 is 13. In contrast, when a loop path is added in FIG. 27, the total of paths stored by the transfer devices 40 is 11. Thus, it is possible to reduce the region for storing entries (paths) without generating a communication disconnection.

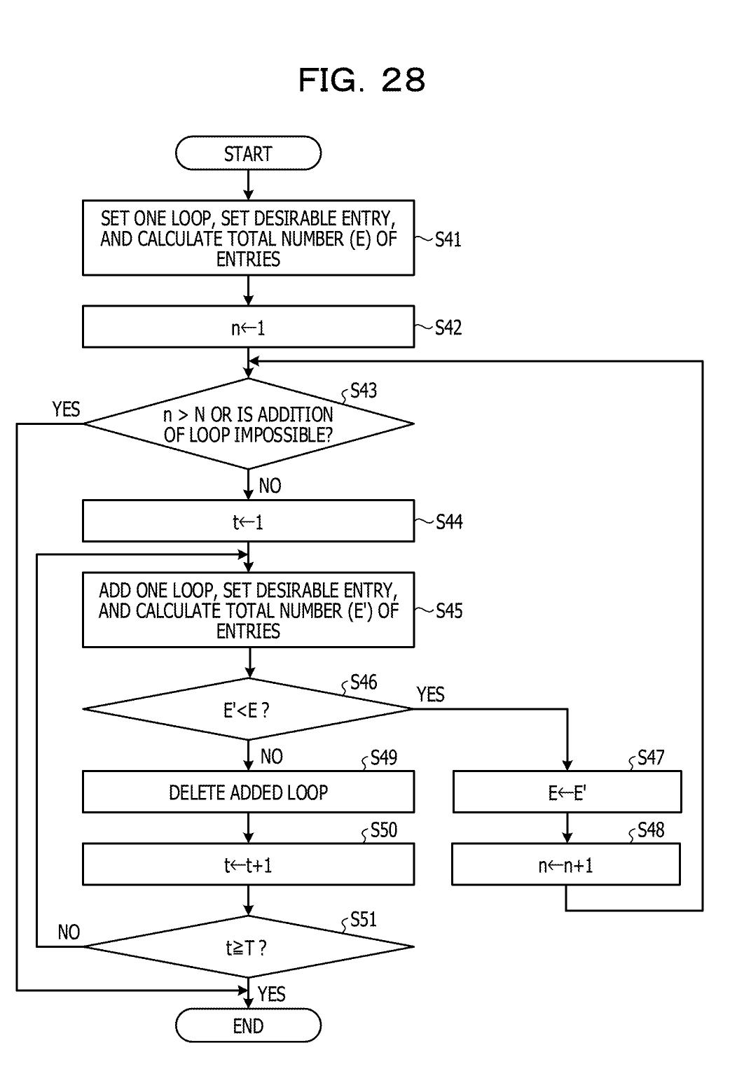

FIG. 28 is a flowchart illustrating example processing of the control device 10 according to the fourth embodiment. Also in the example of FIG. 28, the control device 10 determines a common prefix as the common identification information, where n is the number of loops, N is an upper limit of the number of loops, t is the number of trials, and T is an upper limit of the number of trials. Each of the upper limits may be set in any manner. A method of generating a loop is the same as in the first to third embodiments, thus a detailed description is omitted.

As illustrated in FIG. 28, the control device 10 sets a loop path, sets a desirable entry for each transfer device 40 according to the loop path, and calculates the total number (E) of entries (S41).

Subsequently, the control device 10 increments the number of loops (n) by 1(S42), and determines whether the number of loops (n) is less than an upper limit (N), or a new loop may be added (S43). Here, when the number of loops (n) is greater than the upper limit (N), or a new loop may not be added (Yes in S43), the control device 10 completes the processing.

On the other hand, when the number of loops (n) is less than or equal to the upper limit (N), or a new loop may be added (No in S43), the control device 10 increments the number of trials (t) by 1(S44).

Subsequently, the control device 10 sets a new loop path, sets a desirable entry for each transfer device 40 according to the loop path, and calculates the total number (E′) of entries (S45). The control device 10 then determines whether or not the total number of entries (E′) is less than the total number of entries (E) (S46). In other words, the control device 10 determines whether or not the number of entries is reduced by addition of a loop.

Here, when the total number of entries (E′) is less than the total number of entries (E) (Yes in S46), the control device 10 sets a value of total number of entries (E) which is to be compared with a new total number of entries (E′) (S47), increments the number of loops (n) by 1 (S48), and repeats S43 and after.

On the other hand, when the total number of entries (E′) is greater than or equal to the total number of entries (E) (No in S46), the control device 10 deletes the added loop path and the entry (S49), and increments the number of trials (t) by 1(S50).

When the number of trials (t) is less than upper limit (T) (No in S51), the control device 10 repeats S45 and after, and when the number of trials (t) is greater than or equal to upper limit (T) (Yes in S51), the control device 10 completes the processing.

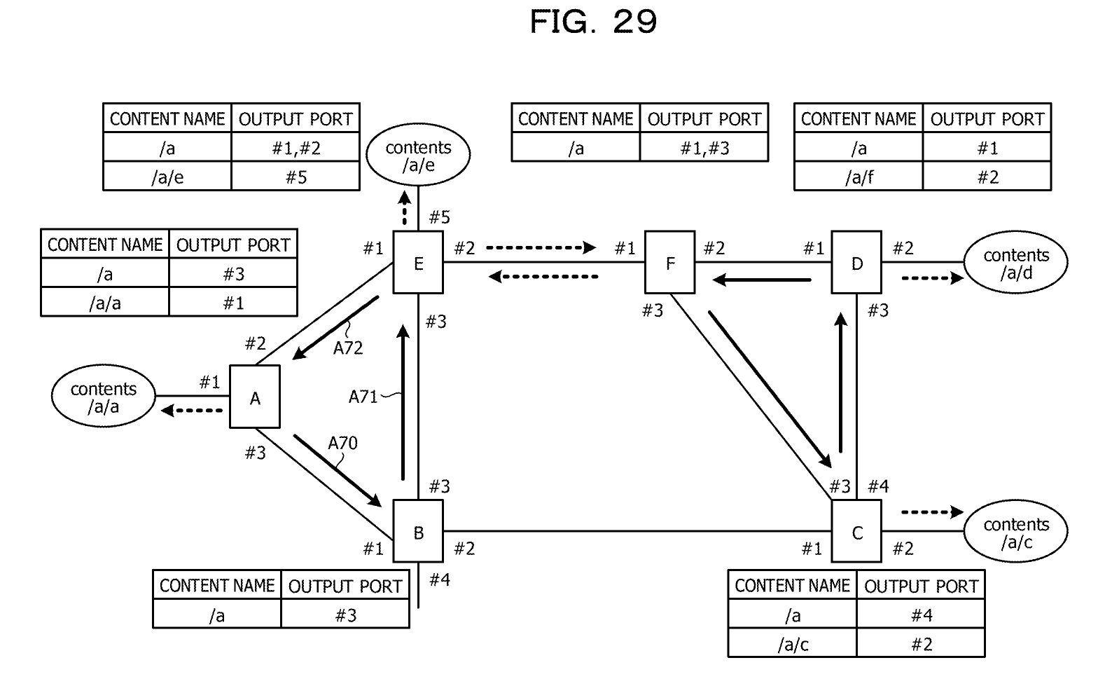

Although an example has been described, in which the transfer device E belongs to two loop paths FIG. 27, the disclosure is not limited to this. For instance, as illustrated in FIG. 29, the processing may be performed similarly even when a transfer device in common in the loop paths is not included.

FIG. 29 is a diagram illustrating another example of the addition control for a loop path. In FIG. 29, it is assumed that the loop path of the transfer devices A-B-E and the loop path of the transfer devices F-C-D, in which a loop is set using the common identification information (/a), are generated. A method of generating a loop is the same as in FIG. 27, thus a detailed description is omitted.

In FIG. 29, in contrast to FIG. 27, a common transfer device in both loop paths is not present. Thus, between the transfer devices belonging to the first loop path and the transfer devices belonging to the second loop path, the control device 10 adds a path (entry), which connects both loop paths, to adjacent transfer devices. In the example of FIG. 29, the control device 10 adds “content name (/a), output port (#2)” to the path from the transfer device E to the transfer device F, and adds “content name (/a), output port (#1)” to the path from the transfer device F to the transfer device E. Here, /a is selected as the content name of an additional path because each of both loop paths is a loop path using the common identification information (/a).

Although an example has been described, in which two loop paths select the same common identification information in the fourth embodiment, the disclosure is not limited to this. For instance, multiple loop paths may select separate pieces of common identification information. In this case, when a path from one loop path to the other loop path is generated, the control device 10 generates an entry of a pair of a content name including common identification information as a connection target and an output port.

As described above, it is possible for the control device 10 to reduce the volume of information transfer tables by forming multiple loops for routing in a network using a common prefix. The embodiments may be combined as appropriate in a range without inconsistency. A transfer device is an example of the node. Although an example of generating two loop paths has been described in the example, three or more loop paths may be handled similarly. The embodiments may be combined as appropriate in a range without inconsistency.

<Others>

The embodiment is not limited to what has been described above, and may be modified in various manners. Some examples will be described below.

For instance, the information elements of the tables stored by the control device 10, the transfer device 40, and the transfer device 70 may be changed according to implementation.

In the third embodiment, although an example has been described, in which integration processing is performed when the number of entries in the information transfer table 61 exceeds a threshold value, the transfer device 70 may be designed to perform integration processing on the paths in the information transfer table 61 when notified of the loop information 64.

In the first and second embodiments, the control device 10 may determine a common prefix by the same processing as the processing described with reference to FIG. 23. Furthermore, the control device 10 may perform integration processing on paths using a common prefix notified by an operator.

The first embodiment and the second embodiment may be used in combination. For instance, when a loop passing through all the transfer devices 40 in a network is found, the integration processing may be performed according to the first embodiment, and when a loop passing through all the transfer devices 40 in a network is not found, the integration processing may be performed according to the second embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication method executed by a processor included in a control device that controls a plurality of transfer devices that store a combination of a content name and a port which is an output destination of an acquisition request for content identified by the content name, the method communication method comprising:
retrieving a loop path that passes through at least part of the plurality of transfer devices;
generating a control packet that requests each of the plurality of transfer devices included in the loop path to replace the combination for content acquirable via the loop path with information on which common identification information included in common in the content name that identifies the content acquirable via the loop path is associated with an output port when the loop path is used; and
transmitting the generated control packet to each of the plurality of transfer devices included in the loop path.

2. The communication method according to claim 1,
wherein the generating includes identifying, for each of the plurality of transfer devices included in the loop path, content other than content stored in a server directly coupled to a transfer device, out of contents identified by a content name that includes the common identification information, as content acquirable by the transfer device via the loop path.

3. The communication method according to claim 1,
wherein the generating includes:
identifying, for each of the transfer devices not included in the loop path, a communication path from a transfer device to one of the plurality of transfer devices included in the loop path; and
generating another control packet that requests the plurality of transfer devices to replace the combination for content other than content stored in a server directly coupled to the plurality of transfer devices, out of contents identified by a content name that includes the common identification information, with information on which the output port used when communication using the communication path is performed is associated with the common identification information, and
the transmitting includes transmitting the generated another control packet.

4. The communication method according to claim 1, wherein
the retrieving includes retrieving a second loop path that passes through part of the plurality of transfer devices as a path to content having the common identification information included in the control packet for a first loop path that passes through part of the plurality of transfer devices, and
the generating includes generating a control packet that requests each of the plurality of transfer devices included in the second loop path to replace the combination for content acquirable via the second loop path with information on which the common identification information in common in the content name that identifies the content acquirable via the second loop is associated with the output port when the second loop path is used.

5. The communication method according to claim 4,
wherein the generating includes generating a control packet that requests the plurality of transfer devices not included in the second loop path and included in the first loop path to delete a path which is from the plurality of transfer devices to the transfer devices included only in the second loop path, and which is not via the first and second loop paths.

6. The communication method according to claim 4,
wherein the generating includes generating a control packet that, when no transfer device included in both the first loop path and the second loop path, requests adjacent transfer devices between the plurality of transfer devices belonging to the first loop path and the plurality of transfer devices belonging to the second loop path to add the combination which identifies a communication path that connects the first and second loop paths.

7. The communication method according to claim 1,
wherein the retrieving includes retrieving the loop path by solving a Hamiltonian cycle problem using topological information on a network having the plurality of transfer devices.

8. The communication method according to claim 1,
wherein each of the plurality of transfer devices included in the loop path is configured to:
when receiving the control packet, replace the combination for the content acquirable via the loop path with information on which the common identification information is associated with the output port when the transfer device uses the loop path, and
when receiving a message to request for acquisition of content, perform replacement processing using the control packet, then transfers the message to an output destination identified from information stored in a storage unit.

9. A control device that controls a plurality of transfer devices that store a combination of a content name and a port which is an output destination of an acquisition request for content identified by the content name, the control device comprising:
a memory; and
a processor coupled to the memory and configured to:
retrieve a loop path that passes through at least part of the plurality of transfer devices;
generate a control packet that requests each of the plurality of transfer devices included in the loop path to replace the combination for content acquirable via the loop path with information on which common identification information included in common in the content name that identifies the content acquirable via the loop path is associated with an output port when the loop path is used; and
transmit the generated control packet to each of the plurality of transfer devices included in the loop path.

10. The control device according to claim 9, wherein the processor is configured to
identify, for each of the plurality of transfer devices included in the loop path, content other than content stored in a server directly coupled to a transfer device, out of contents identified by a content name that includes the common identification information, as content acquirable by the transfer device via the loop path.

11. The control device according to claim 9, wherein the processor is configured to:
identify, for each of the transfer devices not included in the loop path, a communication path from a transfer device to one of the plurality of transfer devices included in the loop path; and
generate another control packet that requests the plurality of transfer devices to replace the combination for content other than content stored in a server directly coupled to the plurality of transfer devices, out of contents identified by a content name that includes the common identification information, with information on which the output port used when communication using the communication path is performed is associated with the common identification information, and
transmit the generated another control packet.

12. The control device according to claim 9, wherein
the retrieving includes retrieving a second loop path that passes through part of the plurality of transfer devices as a path to content having the common identification information included in the control packet for a first loop path that passes through part of the plurality of transfer devices, and
the generating includes generating a control packet that requests each of the plurality of transfer devices included in the second loop path to replace the combination for content acquirable via the second loop path with information on which the common identification information in common in the content name that identifies the content acquirable via the second loop is associated with the output port when the second loop path is used.

13. The control device according to claim 12,
wherein the generating includes generating a control packet that requests the plurality of transfer devices not included in the second loop path and included in the first loop path to delete a path which is from the plurality of transfer devices to the transfer devices included only in the second loop path, and which is not via the first and second loop paths.

14. A system comprising:
a plurality of transfer devices; and
a control device that controls the plurality of transfer devices,
wherein a transfer device in the plurality of transfer devices includes:
a first memory configured to store combinations of a content name and a port which is an output destination of an acquisition request for content identified by the content name, and
a first processor coupled to the first memory and configured to:
when a connection port connected to a loop path including the transfer device is notified, update the combination for content not stored in a server connected to the transfer device out of the combinations stored in the first memory with information on which common identification information in common in identification information that identifies the content not stored in the server is associated with the connection port, and
when a message to request for acquisition of content is received, transfer the message to an output destination identified using the information stored in the first memory,
wherein the control device includes:
a second memory; and
a second processor coupled to the second memory and configured to:
retrieve a loop path that passes through at least part of the plurality of transfer devices;
generate a control packet that requests each of the plurality of transfer devices included in the loop path to replace the combination for content acquirable via the loop path with information on which common identification information included in common in the content name that identifies the content acquirable via the loop path is associated with an output port when the loop path is used; and
transmit the generated control packet to each of the plurality of transfer devices included in the loop path.
